(19) United States
(12) Patent Application Publication
(10) Pub. No.: US 2017/0132251 A1
(43) Pub. Date: May 11, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Qianru QIU, Kanagawa (JP); Yuhei SHIMADA, Kanagawa (JP); Kengo OMURA, Kanagawa (JP)

(73) Assignee: FUJI XEROX CO., LTD., Tokyo (JP)

(21) Appl. No.: 15/131,414

(22) Filed: Apr. 18, 2016

(30) Foreign Application Priority Data
Nov. 10, 2015 (JP) 2015-220398

(51) Int. Cl. G06F 17/30; G06Q 10/10

(52) U.S. Cl. CPC G06F 17/30256; G06F 17/3053; G06Q 10/109

(57) ABSTRACT

An information processing apparatus includes a storing unit, a receiving unit, and a creation unit. The storing unit stores affective information indicating an impression, and a design element defining designs and conforming to the impression indicated by the affective information, in association with each other. The receiving unit receives object affective information indicating an impression for an object of design creation. In a case where the object affective information is stored in the storing unit, the creation unit creates an output related to design for the object by using a design element associated with the object affective information. In a case where the object affective information is not stored in the storing unit, the creation unit creates the output by performing interpolation using a design element associated with other affective information which is stored in the storing unit and for which a relationship with the object affective information is defined.

### CROSS-REFERENCE TO RELATED APPLICATIONS

This application is based on and claims priority under 35 USC 119 from Japanese Patent Application No. 2015-220398 filed Nov. 10, 2015.

### BACKGROUND

(i) Technical Field

The present invention relates to an information processing apparatus, an information processing method, and a non-transitory computer readable medium.

(ii) Related Art

Affective information indicating an impression, which has been defined in advance, is designated by a user, and a design having the impression may be created for an object of design creation.

### SUMMARY

According to an aspect of the invention, an information processing apparatus includes a storing unit, a receiving unit, and a creation unit. The storing unit stores affective information indicating an impression, and a design element which defines designs and conforms to the impression indicated by the affective information, in association with each other. The receiving unit receives object affective information indicating an impression for an object of design creation. In a case where the object affective information is stored in the storing unit, the creation unit creates an output related to design for the object by using a design element associated with the object affective information. In a case where the object affective information is not stored in the storing unit, the creation unit creates the output by performing interpolation using a design element associated with other affective information which is stored in the storing unit and for which a relationship with the object affective information is defined.

### BRIEF DESCRIPTION OF THE DRAWINGS

Exemplary embodiments of the present invention will be described in detail based on the following figures, wherein:

FIG. 1 is a block diagram illustrating a design creation system according to an exemplary embodiment of the present invention;

FIG. 2 is a block diagram illustrating a design creation device according to the exemplary embodiment;

FIG. 3 is a block diagram illustrating a terminal device;

FIG. 4 is a diagram illustrating an example of an image map;

FIG. 5 is a diagram illustrating an example of affective scores of design elements for taste;

FIG. 6 is a diagram illustrating an example of affective scores of design elements for the taste;

FIG. 7 is a diagram illustrating an example of an affective evaluation table;

FIG. 8 is a diagram illustrating an example of a relationship table;

FIG. 9 is a diagram illustrating an example of an image map table;

FIG. 10 is a diagram illustrating an example of a synonym table;

FIG. 11 is a diagram illustrating another example of the affective evaluation table;

FIG. 12 is a diagram illustrating another example of the relationship table;

FIG. 13 is a diagram illustrating another example of the image map table;

FIG. 14 is a diagram illustrating another example of the synonym table;

FIG. 15 is a flowchart illustrating a process executed by a design creation device according to the exemplary embodiment;

FIG. 16 is a diagram illustrating an example of an image map;

FIG. 17 is a diagram illustrating an example of a business card information registration screen;

FIG. 18 is a diagram illustrating an example of a design of a business card;

FIG. 19 is a diagram illustrating an example of personal information;

FIG. 20 is a diagram illustrating an example of adjacent affective words according to Example 1;

FIG. 21 is a diagram illustrating an example of affective scores (raw data) of design elements for the adjacent affective words according to Example 1;

FIG. 22 is a diagram illustrating an example of estimated values of the affective scores (raw data) of the design elements for an object affective word according to Example 1;

FIG. 23 is a diagram illustrating an example of design elements that are estimated for the object affective word according to Example 1;

FIG. 24 is a diagram illustrating an example of synonyms of an object affective word according to Example 2;

FIG. 25 is a diagram illustrating an example of coordinate data of the synonyms according to Example 2;

FIG. 26 is a diagram illustrating an example of coordinate data of the adjacent affective words according to Example 2;

FIG. 27 is a diagram illustrating an example of adjacent affective words according to Example 3;

FIG. 28 is a diagram illustrating an example of the adjacent affective words according to Example 3;

FIG. 29 is a diagram illustrating an example of affective scores (raw data) of design elements for the adjacent affective words according to Example 3;

FIG. 30 is a diagram illustrating an example of estimated values of affective scores (raw data) of design elements for an object affective word according to Example 3;

FIG. 31 is a diagram illustrating an example of design elements that are estimated for the object affective word according to Example 3;

FIG. 32 is a diagram illustrating an example of adjacent affective words according to Example 4;

FIG. 33 is a diagram illustrating an example of affective scores (raw data) of design elements for the adjacent affective words according to Example 4;

FIG. 34 is a diagram illustrating an example of affective scores (raw data) of design elements for an object affective word according to Example 4;

FIG. 35 is a diagram illustrating an example of design elements that are estimated for the object affective word according to Example 4;

FIG. 36 is a diagram illustrating an example of synonyms of an object affective word according to Example 5;

FIG. 37 is a diagram illustrating an example of coordinate data of the synonyms according to Example 5;

FIG. 38 is a diagram illustrating an example of coordinate data of adjacent affective words according to Example 5;

FIG. 39 is a diagram illustrating an example of synonyms of object affective words according to Example 6;

FIG. 40 is a diagram illustrating an example of coordinate data of synonyms according to Example 6;

FIG. 41 is a diagram illustrating an example of coordinate data of synonyms according to Example 6; and

FIG. 42 is a diagram illustrating an example of coordinate data of adjacent affective words according to Example 6.

### DETAILED DESCRIPTION

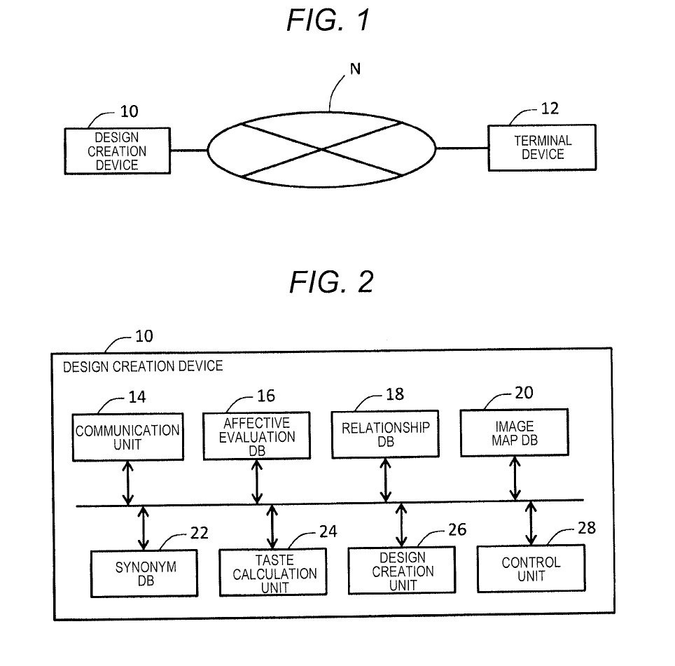

FIG. 1 illustrates an example of a design creation system as an information processing system according to an exemplary embodiment of the present invention. The design creation system includes a design creation device 10 as an image processing apparatus, and a terminal device 12. The design creation device 10 and the terminal device 12 are connected to a communication path N such as a network. In the example illustrated in FIG. 1, a single terminal device 12 is connected to the communication path N, but plural terminal devices 12 may be connected to the communication path N.

The design creation device 10 is provided with a function of creating a design of an object, having a certain taste (impress ion) depending on a demand, and provides data representing the design of the object (for example, such as image data and template data of the object) as an output. The object is, for example, business cards, handbills, advertisements, direct mail (DM), posters, postcards, catalogs, and other documents, clothes, cars, buildings, bridges, or the like. Further, the design creation device 10 has a function of transmitting and receiving data to and from other devices.

The terminal device 12 is, for example, a device such as a personal computer (PC), a tablet PC, a smart phone, and a mobile phone, and has a function of transmitting and receiving data to and from other devices. The terminal device 12 is used, for example, when creating a design.

In the present exemplary embodiment, when creating a design, information which is a base for creating a design is transmitted from the terminal device 12 to the design creation device 10, and the design creation device 10 creates a design based on the information.

The terminal device 12 may be built in the design creation device 10 so that the design creation device 10 and the terminal device 12 make up a physically integrated device.

Hereinafter, the configuration of the design creation device 10 will be described in detail with reference to FIG. 2. FIG. 2 illustrates the configuration of the design creation device 10.

The communication unit 14 is a communication interface, and includes a function of transmitting data to another device, and a function of receiving data from another device, through the communication path N. For example, the communication unit 14 transmits data indicating the design of an object to the terminal device 12, and receives information (for example, information which is a base for creating a design) that has been transmitted from the terminal device 12.

An affective evaluation database (DB) 16 is a storage device such as a hard disk, and stores affective score raw data. The affective score raw data is data which is generated in advance for every object of design creation and for every taste, and represents an association between affective information representing the taste (impression) of a design and an affective score (evaluation value) representing a degree of conformance (degree of association) of each design element to the taste. The taste is determined in advance, for example, based on a preference model that classifies a person's impression for a certain object. The object of design creation includes, for example, plural design categories (design parts and design items), and the design element defines the design of each design category (each design part and each design item) constituting the object. Plural design elements are defined for respective individual design categories, and the affective score of each design element for a taste is obtained in advance. The affective score is, for example, a value obtained by an affective evaluation experiment according to Quantification Theory Type 1. For example, the more the taste (impression) of a design element matches the taste of design, the higher the degree of conformance (degree of association) of the design element is.

Further, the affective evaluation DB 16 stores affective evaluation data. The affective evaluation data is data which is generated in advance for every object of design creation and for every taste, and represents the association between affective information indicating the taste of the design, and a conforming design element that conforms to (is related) the taste. The conforming design element is evaluated as a design element having a certain taste corresponding to the design. The conforming design element that conforms to the taste of design is specified in advance for each of individual design categories constituting the object, and the conforming design element is represented as the affective evaluation data. For example, the conforming design element is determined based on the affective scores (degrees of conformance) from among the plural design elements belonging to the design category, for each of the individual design categories constituting the object. Specifically, the design element having the highest affective score is adopted as the conforming design element, for each of the individual design categories constituting the object. The affective evaluation data is obtained from, for example, the above-mentioned affective score raw data.

A relationship database (DB) 18 is a storage device such as a hard disk, and stores the relationship data indicating a relationship between respective pieces of affective information. The relationship data is data which is generated in advance, and represents the closeness of respective tastes between respective pieces of affective information. The affective information is an affective word indicating, for example, a taste, and the closeness of meanings between respective affective words is defined in the relationship data. The closeness of meanings between respective affective words is defined by referring to the relationship data.

An image map database (DB) 20 is a storage device such as a hard disk. The taste indicated by the affective information is digitized, and the numerical value is stored in the image map DB 20. For example, the image map DB 20 stores the image map data. The image map is a one-dimensional or multi-dimensional map representing the distribution of the taste (impression). The taste indicated by the affective information is defined as a coordinate on the image map.

A synonym database (DB) 22 is a storage device such as a hard disk, and stores synonym data. The synonym data is the data that is generated in advance, and indicates the association between the affective word and the synonym (synonymous term) of the affective word.

It is assumed that the relationship of C>B>A is established, by comparing the number A of affective information pieces (for example, affective words) which are defined in the affective evaluation data, the number B of affective information pieces which are defined as the relationship data, and the number C of affective information pieces which are defined as synonym data. Of course, this relationship is only an example, and other relationships (arbitrary relationship) may be established.

A taste calculation unit 24 has a function of receiving object affective information indicating the taste for an object of design creation, and calculating a taste for creating the design of the object. Specifically, the taste calculation unit 24 determines a design element for creating the design of the object for respective individual design categories constituting the object.

For example, in a case where the object affective information is stored in the affective evaluation DB 16, in other words, in a case where the object affective information is included in the affective evaluation data, the taste calculation unit 24 employs the taste indicated by the object affective information, as a taste for creating the design of the object. Specifically, the taste calculation unit 24 employs the conforming design element associated with the object affective information, as a design element for creating the design of the object.

In a case where the object affective information is not stored in the affective evaluation DB 16, in other words, in a case where the object affective information is not included in the affective evaluation data, the taste calculation unit 24 searches the relationship DB 18. In a case where the object affective information is stored in the relationship DB 18, in other words, in a case where the object affective information is included in the relationship data, the taste calculation unit 24 calculates a taste for creating the design of the object, by performing interpolation using the taste indicated by other affective information for which a relationship with the object affective information is defined. Specifically, the taste calculation unit 24 calculates a design element for creating the design of the object, by performing interpolation using the conforming design element associated with the other affective information.

In a case where the object affective information is not stored in any of the affective evaluation DB 16 and the relationship DB 18, in other words, in a case where the object affective information is not included in any of the affective evaluation data and the relationship data, the taste calculation unit 24 searches the synonym DB 22.

In a case where the object affective information is stored in the synonym DB 22, in other words, in a case where the affective word indicated by the object affective information is included in the synonym data, the taste calculation unit 24 acquires a synonym from the synonym data, determines the other affective information by using the synonym, performs interpolation by using the taste indicated by the other affective information, and calculates the taste for creating the design of the object.

A design creation unit 26 has a function of generating data representing the design of the object of design creation (for example, the image data and the template data of the object) as an output, according to the taste that has been employed or calculated by the taste calculation unit 24. Specifically, the design creation unit 26 generates data representing the design of the object, by using the design element that is employed or calculated by the taste calculation unit 24.

A control unit 28 has a function of controlling the operation of each unit of the design creation device 10.

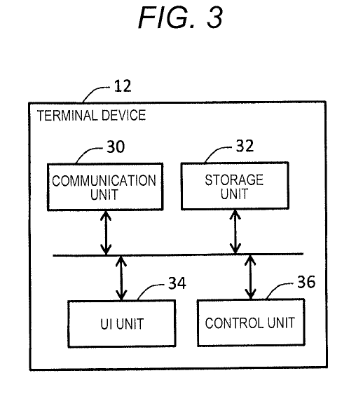

The configuration of the terminal device 12 will be described in detail with reference to FIG. 3. FIG. 3 illustrates the configuration of the terminal device 12.

A communication unit 30 is a communication interface, and has a function of transmitting data to another device, and a function of receiving data from another device, through the communication path N. For example, the communication unit 30 transmits information which is a base for creating a design to the design creation device 10, and receives data indicating the design that has been transmitted from the design creation device 10. A storage unit 32 is a storage device such as a hard disk, and stores a program and data. A UI unit 34 is a user interface, and includes an operation unit and a display unit. The display unit is, for example, a display device such as a liquid crystal display, and the operation unit is, for example, an input device such as a keyboard, a mouse, and a touch panel. A control unit 36 has a function of controlling the operation of each unit of the terminal device 12.

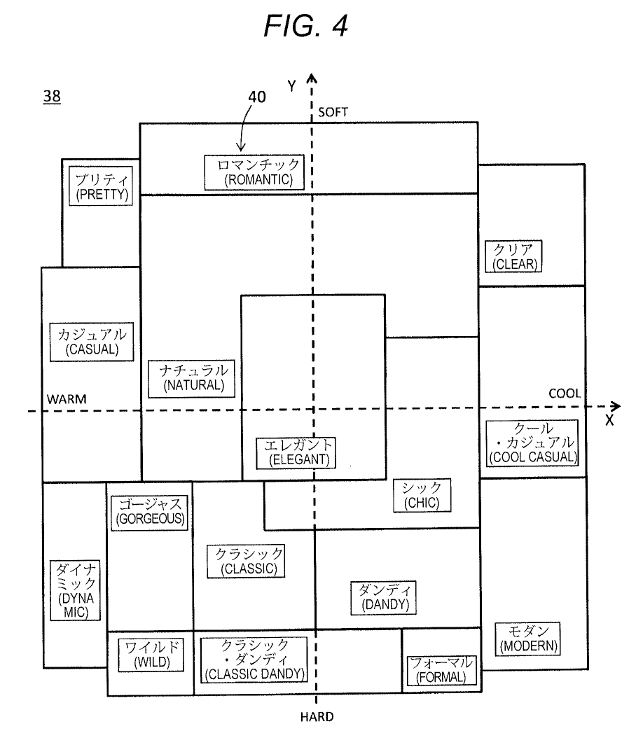

The image map will be described in detail with reference to FIG. 4. FIG. 4 illustrates an example of the image map. The image map 38 is, for example, a two-dimensional map defined in two axes (x-axis, y-axis). The affective information is associated in advance with each coordinate on the image map 38. The taste (impression) corresponding to the coordinate is specified by designating a coordinate on the image map 38. In the image map 38, the horizontal axis (x-axis) is an index axis defining the indicators “WARM” and “COOL” of the tastes, and the vertical axis (y-axis) is an index axis defining the indicators “HARD” and “SOFT” of the tastes. For example, the closer to the area on the right side, the stronger the impression “COOL” becomes. In other words, the closer to the area on the right side, the more taste having the stronger “COOL” sensation is associated therewith. Meanwhile, the closer to the area on the left side, the stronger the impression “WARM” becomes. In other words, the closer to the area on the left side, the more taste having the stronger “WARM” sensation is associated therewith. In addition, the closer to the area on the top side, the stronger the impression “SOFT” becomes. In other words, the closer to the area on the top side, the more taste having the stronger “SOFT” sensation is associated therewith. Meanwhile, the closer to the area on the bottom side, the stronger the impression “HARD” becomes. In other words, the closer to the area on the bottom side, the more taste having the stronger “HARD” sensation is associated therewith.

In the example illustrated in FIG. 4, the image map 38 is divided into plural regions, and affective information (for example, the taste ┌ [symbol] ┘ (“Romantic”) indicated by 40, or the like) is associated with each region. The image map 38 is generated in advance, and the data is stored in advance in the image map DB 20. A different image map may be defined for each object, and a common image map may be defined for the plural objects. Incidentally, the image map may be a three or more dimensional map, or may be a one dimensional map.

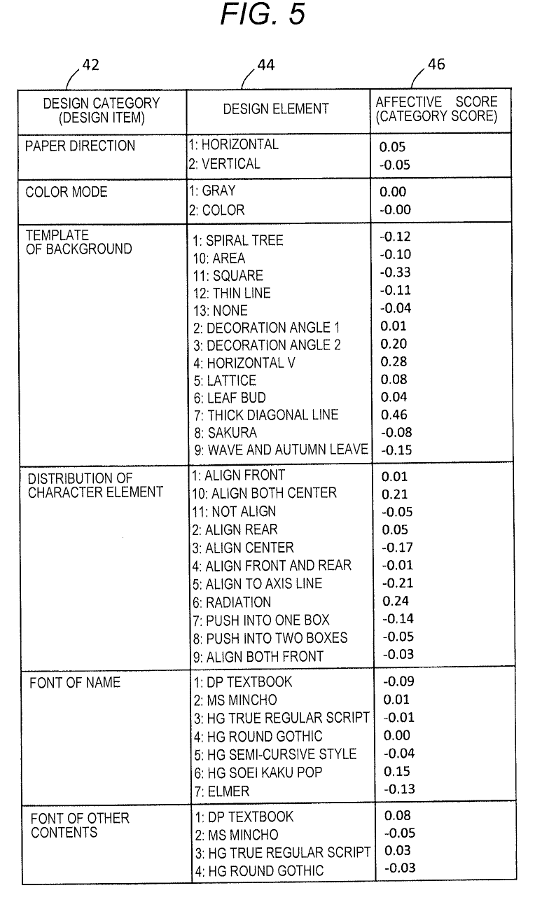

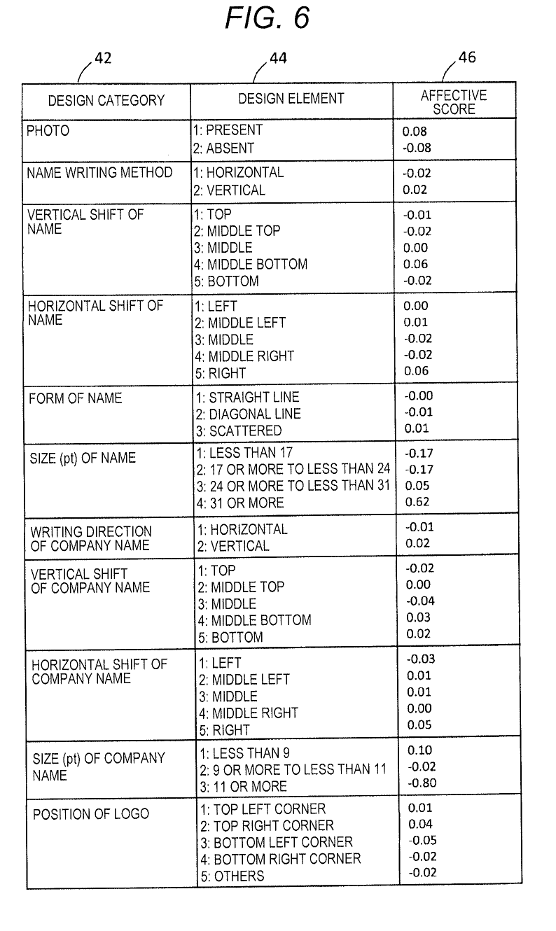

Hereinafter, the structure of each piece of data that is stored in the design creation device 10 will be described. FIGS. 5 and 6 illustrate examples of affective score raw data. The affective score raw data is data which is generated in advance for every object of design creation and for every taste of design, and is stored in the affective evaluation DB 16. In the affective score raw data, a design category (design item) 42, a design element 44, and an affective score 46 are associated with each other. The design category is individual design parts constituting the object. One or plural design elements are defined in each design category. Each design element is an element that defines the design of the design category. The affective score is a value that indicates the degree of conformance of the design element to the taste, and is, for example, a value obtained by the analysis of the Quantification Theory Type 1.

In the examples illustrated in FIGS. 5 and 6, the object is “Business card”, and the taste of design is ┌ [symbol] ┘ (“Dynamic”). In other words, the affective score raw data illustrated in FIGS. 5 and 6 is data that indicates the degree of conformance of each design element to the taste ┌ [symbol] [symbol] ┘ (“Dynamic”), with the object as “Business card”. As an example, “Paper direction”, “Color mode”, “Template of background”, “Distribution of character element”, and the like are the design categories of the object “Business card”. One or plural design elements are defined for each design category, and the degree of conformance of each design element to the taste ┌ [symbol] ┘ (“Dynamic”) is obtained. As an example, it is evaluated that the higher the affective score of a design element is, the better the taste (impression) of the design element conforms to the taste ┌ [symbol] ┘ (“Dynamic”) and the more suitable the design element is for the taste ┌ [symbol] [symbol] ┘ (“Dynamic”).

For example, the affective score of the design element “1: Horizontal” is “0.05”, and the affective score of the design element “2: Vertical” is “−0.05”, with respect to the design category “Paper direction”. In other words, it is evaluated that the design element “1: Horizontal” more appropriately represents the taste ┌ [symbol] ┘ (“Dynamic”) than the design element “2: Vertical”, with respect to “Paper direction” of the object “Business card”. In other words, it is evaluated that the design element “1: Horizontal” gives a more dynamic impression than the design element “2: Vertical”.

In addition, the affective score of the design element “Thick diagonal line” has the highest score with respect to the design category “Template of background”. In other words, it is evaluated that the design element “7. Thick diagonal line” more appropriately represents the taste ┌ [symbol] ┘ (“Dynamic”) as compared to other design elements, with respect to “Template of background” of the object “Business card”. In other words, it is evaluated that the design element “7: Thick diagonal line” gives a more dynamic impression, as compared to other design elements.

With respect to the object “Business card”, the design category and the design element which are the same as the design category and the design element illustrated in FIGS. 5 and 6 are defined for tastes other than the taste ┌ [symbol] ┘ (“Dynamic”), and the affective score of each design element is obtained. With respect to the object “Business card”, the affective score raw data for each taste is generated in advance, and stored in the affective evaluation DB 16.

In addition, although the case of the object “Business card” is illustrated in the examples illustrated in FIGS. 5 and 6, the affective score raw data for each taste is generated in advance, and stored in the affective evaluation DB 16 with respect to other objects in the same manner. For example, each piece of affective score raw data is generated in advance, and stored in the affective evaluation DB 16 with respect to advertisements, handbills, posters, postcards, and other documents, clothes, cars, buildings, bridges, or the like. The design category and the design element are defined for each object, and the affective score of each design element is obtained. For example, different design categories and design elements are defined for “Business card” and “Advertisement”.

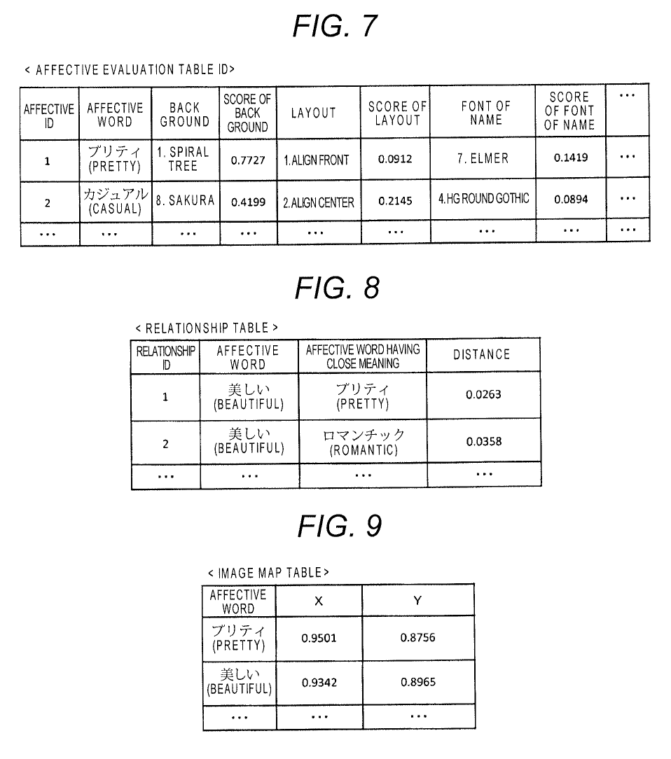

The affective evaluation data is obtained, based on the above-mentioned affective score raw data. FIG. 7 illustrates an example of the affective evaluation table as the affective evaluation data. The affective evaluation table is the affective evaluation table for “Business card” which is generated in advance based on the affective score raw data for the object “Business card”, and the data is stored in the affective evaluation DB 16. In the affective evaluation table, the affective ID, the affective word, the conforming design element for each design category (design part), and the affective score of the conforming design element are associated with each other. The affective word is an example of the affective information indicating a taste. In the example illustrated in FIG. 7, ┌ [symbol] ┘ (“Pretty”), ┌ [symbol] ┘ (“Casual”), and the like are included in the affective evaluation table, as the affective words. As described above, the design category is the design part constituting the object “Business card”, and “(Template of) background”, “Layout of (character)”, “Font of name”, and the like are included in the affective evaluation table as the design category, in the example illustrated in FIG. 7. The conforming design element is the design element having the highest affective score (degree of conformance) among plural design elements which are defined for the design category to which the design element belongs.

If a description will be made regarding the taste ┌ [symbol] [symbol] ┘ (“Pretty”), the affective score (0.7727) of the design element “1. Spiral tree” is the highest among the plural design elements belonging to the design category “(Template of) background”. Therefore, the design element “1. Spiral tree” is selected as the conforming design element related to the design category “(Template of) background”. In addition, the affective score (0.0912) of “1. Front align” is the highest among the plural design elements belonging to the design category “Layout of (character)”. Therefore, the design element “1. Front align” is selected as the conforming design element related to the design category “Layout of (character)”. In addition, the affective score (0.1419) of “7. Elmer” is the highest among the plural design elements belonging to the design category “Font of name”. Therefore, the design element “7. Elmer” is selected as the conforming design element related to the design category “Font of name”.

The design elements having the highest affective score are selected as the conforming design elements for other tastes (affective words) and other design categories in the same manner. In addition, the conforming design element is selected and the affective evaluation table is generated for objects other than “Business card” in the same manner.

The design element having the highest affective score is included for each design category in the affective evaluation table. Therefore, since the conforming design element corresponding to the designated taste (affective word) is acquired from the affective evaluation table, and the object is designed by using the conforming design element, the design having the designated taste is created.

The relationship data will be described with reference to FIG. 8. FIG. 8 illustrates an example of the relationship table as the relationship data. The relationship table is a table that is generated in advance for the object “Business card”, and the data is stored in the relationship DB 18. In the relationship table, a relationship ID, an affective word, an affective word having close meaning, and a distance are associated with each other. The affective word having close meaning is an example of the affective information indicating a taste, and an affective word having the meaning close to the meaning of the corresponding affective word, in other words, an affective word indicating a taste close to the taste indicated by the corresponding affective word. The distance is an index value indicating the closeness between respective meanings (tastes) of the respective affective words, and is, for example, a distance on the image map (see FIG. 4). The affective word having a meaning (taste) close to a certain affective word is specified, by referring to the relationship table.

For example, the affective word ┌ [symbol] ┘ (“Pretty”) as the affective word having the close meaning is associated with the affective word ┌ [symbol] ┘ (“Beautiful”). A distance between the coordinates of the taste ┌ [symbol] ┘ (“Beautiful”) and the coordinates of the taste ┌ [symbol] ┘ (“Pretty”) is 0.0263 on the image map. The smaller the value, the closer the meaning (taste) of both affective words is.

The image map table will be described with reference to FIG. 9. FIG. 9 illustrates an example of the image map table. The image map table is a table that indicates the coordinates of each affective word (taste) on the image map for the object “Business card”, and the data is generated in advance and stored in the image map DB 20. In the example illustrated in FIG. 9, with respect to the affective words ┌ [symbol] ┘(“Pretty”), ┌ [symbol] ┘(“Beautiful”), and the like, the coordinates (x, y) thereof on the image map are included in the image map table.

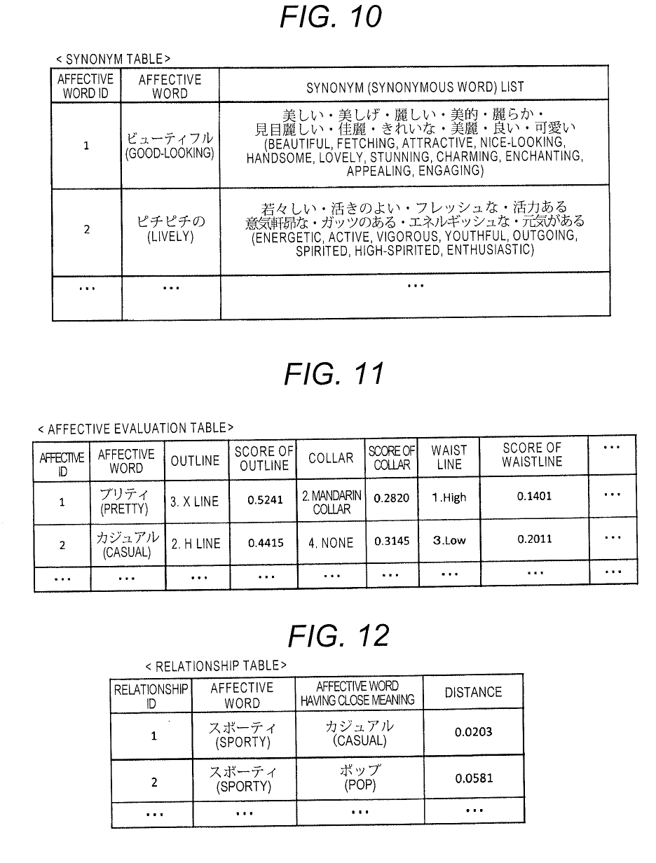

The synonym data will be described with reference to FIG. 10. FIG. 10 illustrates an example of the synonym table as the synonym data. The synonym table is a table that is generated in advance for the object “Business card”, and the data is stored in the synonym DB 22. In the synonym table, an affective word ID, an affective word, and a synonym (or a synonymous term) are associated with each other. The synonym is an affective word having the meaning close to the meaning of the corresponding affective word, in other words, an affective word indicating a taste close to the taste indicated by the corresponding affective word. The synonymous term of the corresponding affective word may be included in a synonym group.

Hereinafter, data related to the objects other than “Business card” will be described with reference to FIGS. 11 to 14. In the examples illustrated in FIGS. 11 to 14, the object is “Clothes”. The affective score raw data for each taste is generated in advance for the object “clothes”, and is stored in the affective evaluation DB 16. In addition, as the image map, the image map for the object “Clothes” may be defined and the same image map as that of the object “Business card” may be used.

The affective evaluation data about the object “Clothes” is obtained based on the affective score raw data about the object “Clothes”. FIG. 11 illustrates an example of the affective evaluation table as the affective evaluation data. The affective evaluation table is an affective evaluation table about “Clothes” which is obtained and generated based on the affective score raw data about the object “Clothes”, the data is stored in the affective evaluation DB 16. Even in the affective evaluation table about “Clothes”, the affective ID, the affective word, the conforming design element for each design category, and the affective score of the conforming design element are associated with each other. In the example illustrated in FIG. 11, ┌ [symbol] ┘ (“Pretty”), ┌ [symbol] ┘ (“Casual”), and the like are included in the affective evaluation table, as the affective word. The design category is a design part constituting the object “Clothes”, and in the example illustrated in FIG. 11, “Outline”, “Collar”, “Waistline”, and the like are included in the affective evaluation table, as the design category. The conforming design element is a design element having the highest affective score (degree of conformance) among plural design elements that are defined for the design category to which the design elements belong.

A description will be made regarding the taste ┌ [symbol] [symbol] ┘ (“Pretty”), and the affective score (0.5241) of the design element “3. X line” is the highest among the plural design elements belonging to the design category “Outline (of clothes)”. Therefore, the design element “3. X line” is selected as the conforming design element related to the design category “Outline (of clothes)”. In addition, the affective score (0.2820) of “2. Mandarin collar” is the highest among the plural design elements belonging to the design category “Collar”. Therefore, the design element “2. Mandarin collar” is selected as the conforming design element related to the design category “Collar”. In addition, the affective score (0.1401) of the design element “1. High” is the highest among the plural design elements belonging to the design category “Waistline (of clothes)”. Therefore, the design element “1. High” is selected as the conforming design element related to the design category “Waistline (of clothes)”. The design element having the highest affective score is selected as the conforming design element for a different taste (affective word) and a different design category in the same manner.

The relationship data for the object “Clothes” will be described with reference to FIG. 12. FIG. 12 illustrates an example of the relationship table as the relationship data. The relationship table is a table that is generated in advance for the object “Clothes”, and the data is stored in the relationship DB 18. For example, the affective word ┌ [symbol] [symbol] ┘ (“Casual”) as the affective word having the close meaning is associated with the affective word ┌ [symbol] ┘ (“Sporty”). A distance between the coordinates of the taste ┌ [symbol] ┘ (“Sporty”) and the coordinates of the taste ┌ [symbol] ┘ (“Casual”) is 0.0203 on the image map.

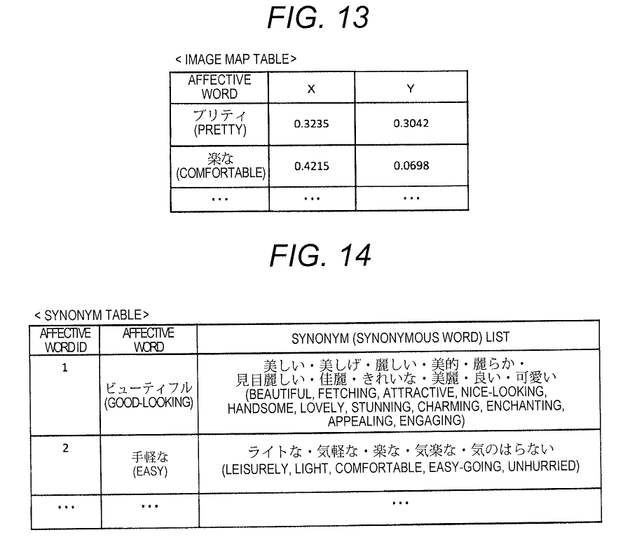

The image map table for the object “Clothes” will be described with reference to FIG. 13. FIG. 13 illustrates an example of the image map table. The image map table is a table that indicates the coordinates of each affective word (taste) on the image map for the object “Clothes”, and the data is generated in advance and is stored in the image map DB 20. In the example illustrated in FIG. 13, with respect to the affective words ┌ [symbol] ┘ (“Pretty”), ┌ [symbol] ┘ (“Comfortable”), and the like, the coordinates (x, y) thereof on the image map are included in the image map table.

The synonym data for the object “Clothes” will be described with reference to FIG. 14. FIG. 14 illustrates an example of the synonym table as the synonym data. The synonym table is a table that is generated in advance for the object “Clothes”, and the data is stored in the synonym DB 22.

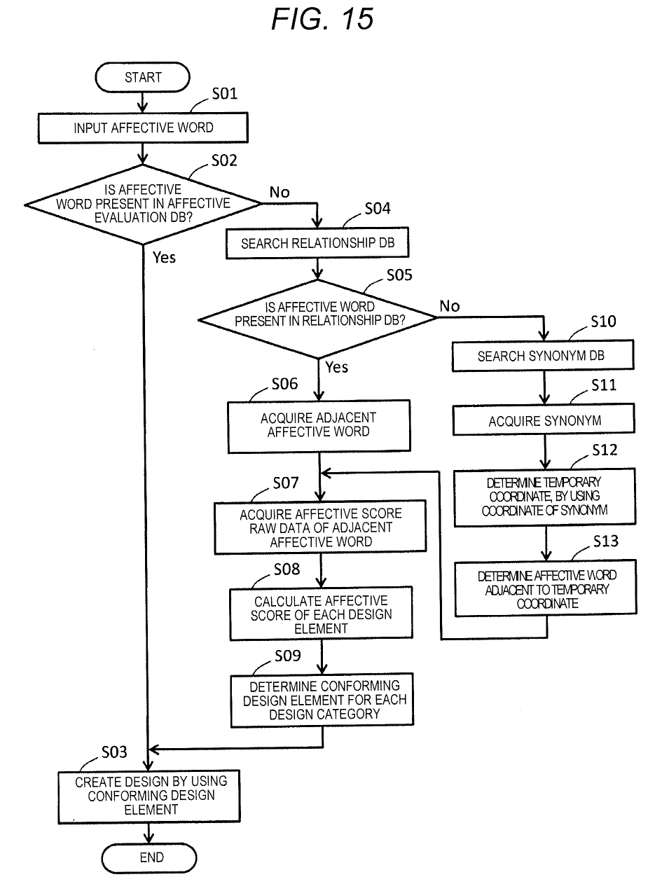

Hereinafter, the process by the design creation device according to the present exemplary embodiment will be described with reference to FIG. 15. FIG. 15 illustrates a flowchart illustrating the process.

At first, an object affective word indicating the taste (impression) for the object of design creation is input by the user (S01). The object affective word corresponds to an example of the object affective information. For example, if the object affective word is input by the terminal device 12, the information indicating the object affective word is transmitted from the terminal device 12 to the design creation device 10 through the communication path N. Of course, the object affective word may be input by the design creation device 10.

Next, the taste calculation unit 24 searches the affective evaluation DB 16 for the object affective word. In a case where the information indicating the object affective word is stored in the affective evaluation DB 16 (S02, Yes), the taste calculation unit 24 employs the conforming design element associated with the object affective word, as a design element for creating the design of the object. The design creation unit 26 generates data indicating the design of the object (for example, the image data, the template data, or the like of the object), by using the conforming design element associated with the object affective word (S03). The data is transmitted from the design creation device 10 to the terminal device 12 through the communication path N. The image, the template, and the like of the object are displayed on the UI unit 34 of the terminal device 12, based on the data.

For example, in a case of designing the object “Business card”, it is assumed that ┌ [symbol] ┘ (“Pretty”) is input as the object affective word. As illustrated in FIG. 7, the object affective word is included in the affective evaluation table. In other words, the information indicating the object affective word is stored in the affective evaluation DB 16. In this case, the design creation unit 26 generates data indicating the design of “Business card”, by using the conforming design element associated with the object affective word ┌ [symbol] ┘ (“Pretty”). In the example illustrated in FIG. 7, the conforming design element “1. Spiral tree” is used as the design of the background of the business card, the conforming design element “1. Front align” is used as the layout of character, and the conforming design element “7. Elmer” is used as the font of name. Thus, as the design of “Business card”, design having a taste ┌ [symbol] ┘ (“Pretty”) which is designated by the user is created. The image and the template of the business card having the design are displayed on the UI unit 34 of the terminal device 12.

Meanwhile, in a case where the information indicating the object affective word is not stored in the affective evaluation DB 16 (S02, No), the taste calculation unit 24 searches the relationship DB 18 for the object affective word (S04). In a case where the information indicating the object affective word is stored in the relationship DB 18 (S05, Yes), the taste calculation unit 24 acquires the adjacent affective word having the impressions included in the adjacent range of the impression indicated by the object affective word from, the relationship DB 18 (S06). The adjacent affective word is an affective word having the meaning close to the meaning of the object affective word. In other words, an affective word indicating a taste close to the taste indicated by the object affective word corresponds to the adjacent affective word. For example, the taste calculation unit 24 acquires the adjacent affective word (affective word having close meaning) associated with the object affective word from the relationship table, by referring to the relationship table illustrated in FIG. 8.

Next, the taste calculation unit 24 acquires the affective score raw data of the adjacent affective word from the affective evaluation DB 16 (S07). In a case where the plural adjacent affective words are extracted, the affective score raw data of each adjacent affective word is acquired.

Next, the taste calculation unit 24 calculates a difference between the taste indicated by the object affective word and the taste indicated by the adjacent affective word, in other words, a distance between the coordinates of the object affective word and the coordinates of the adjacent affective word on the image map. Then, the taste calculation unit 24 calculates the affective score of each design element of the taste indicated by the object affective word, for each design category, by using the distance and the affective score of the design element associated with the adjacent affective word (S08). Then, the taste calculation unit 24 determines the conforming design element that conforms to the taste indicated by the object affective word, based on the affective score (S09). The taste calculation unit 24 selects, for example, the design element having the highest affective score from among plural design elements belonging to the design category, as the applicable design element, for each design category. The data indicating the design of the object is generated by using the applicable design element (S03). The data is transmitted to the terminal device 12, and the image and the template for the object are displayed on the terminal device 12.

Meanwhile, in a case where the information indicating the object affective word is not stored in the relationship DB 18 (S05, No), the taste calculation unit 24 searches the synonym DB 22 for the object affective word (S10), and acquires the synonym of the object affective word from the synonym DB 22 (S11). For example, the taste calculation unit 24 extracts the synonym (synonymous term) of the object affective word, by referring to the synonym table illustrated in FIG. 10. Next, the taste calculation unit 24 determines the temporary coordinates of the object affective word by using the coordinates of the extracted synonym on the image map (S12). As an example, three synonyms are extracted from the synonym table, the circle including the coordinates of each synonym is formed on the affective map, and the center coordinates of the circle is specified. Next, the synonym corresponding to the farthest coordinate from the center coordinate is extracted from among synonym groups included in the synonym table. In a case where the coordinates of the extracted synonym is included in the circle, the center coordinate is specified as a temporary coordinates of the object affective word. In a case where the coordinates of the extracted synonym is not included in the circle, one of the three synonyms is replaced by the synonym corresponding to the farthest coordinate, and the process described above is executed on three synonyms obtained by the replacement. The above process is repeated until the coordinates of the synonym corresponding to the farthest coordinate is included in the circle. In a case where the temporary coordinates of the object affective word is specified, the taste calculation unit 24 specifies the affective word adjacent to the temporary coordinate (adjacent affective word) (S13). Next, step S07 and the subsequent process is executed.

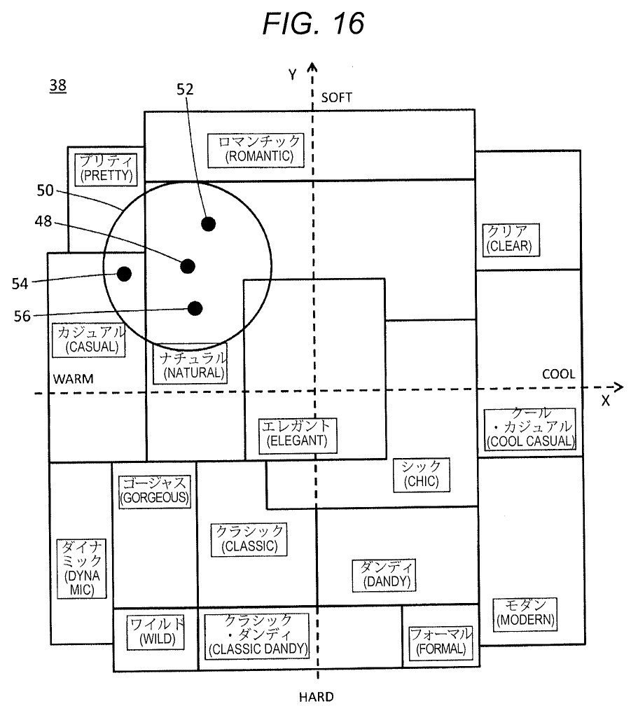

Hereinafter, the processes of steps S06 to S09 will be described in detail with reference to FIG. 16. FIG. 16 illustrates an example of the image map. The reference numeral indicates the coordinate corresponding to the object affective word (for example, taste ┌ [symbol] ┘ (“Lovely”)). The reference numeral 50 represents the extraction range of affective word. The extraction range is, for example, the circular range centered on the coordinates of the object affective word. The size and the shape of the range are determined in advance, and they may be arbitrarily changed. In a case where the object affective word is not stored in the affective evaluation DB 16, the affective word corresponding to coordinate within the extraction range is extracted as the adjacent affective word. For example, the affective words corresponding to the respective coordinates indicated by the reference numerals 52, 54 and 56 are extracted as the adjacent affective words. The coordinate indicated by the reference numeral 52 corresponds to the taste ┌ [symbol] ┘ (“Youthful”), the coordinate indicated by the reference numeral 54 corresponds to the taste ┌ [symbol] ┘ (“Pretty”), and the coordinate indicated by the reference numeral 56 corresponds to the taste ┌ [symbol] ┘ (“playful”).

The process of step S08 described above (an arithmetic process of the affective score of each design element for the taste indicated by the object affective word) is, specifically, executed according to the following procedure. The following process is executed by the taste calculation unit 24.

First, the distance between the coordinates of the object affective word and the coordinates of the adjacent affective word on the image map 38 are calculated, according to the following Equation (1).

$${Dist}_{1} = \sqrt{{( {x}_{t}^{2} - {x}_{1}^{2} )}^{2} + {( {y}_{t}^{2} - {y}_{1}^{2} )}^{2}} \\ {Dist}_{2} = \sqrt{{( {x}_{t}^{2} - {x}_{2}^{2} )}^{2} + {( {y}_{t}^{2} - {y}_{2}^{2} )}^{2}} \\ ⋯ \\ {Dist}_{n} = \sqrt{{( {x}_{t}^{2} - {x}_{n}^{2} )}^{2} + {( {y}_{t}^{2} - {y}_{n}^{2} )}^{2}} \qquad ( 1 )$$

(xₜ, yₜ) is the coordinates of the object affective word. (x₁, y₁) is the coordinate indicated by the reference numeral 52 (the coordinates of the adjacent affective word). (x₂, y₂) is the coordinate indicated by the reference numeral 54 (the coordinates of the adjacent affective word). (xₙ, Yₙ) is the coordinate indicated by the reference numeral 56 (the coordinates of the adjacent affective word). n is the number of adjacent affective words which are included in the extraction range. Dist₁ is a distance between the object affective word ┌ [symbol] ┘ (“Lovely”) and the adjacent affective word ┌ [symbol] ┘ (“Youthful”). Dist₂ is a distance between the object affective word ┌ [symbol] ┘ (“Lovely”) and the adjacent affective word ┌ [symbol] ┘ (“Pretty”). Distₙ is a distance between the object affective word ┌ [symbol] ┘ (“Lovely”) and the adjacent affective word ┌ [symbol] ┘ (“playful”).

Next, the ratio of each distance with respect to the sum of the distances is calculated, according to the following Equation (2).

$${Rateof Dist}_{1} = \frac{{Dist}_{1}}{{Dist}_{1} + {Dist}_{2} + ⋯ + {Dist}_{n}} \\ Rate {of Dist}_{2} = \frac{{Dist}_{2}}{{Dist}_{1} + {Dist}_{2} + ⋯ + {Dist}_{n}} \\ ⋯ \\ {Rateof Dist}_{n} = \frac{{Dist}_{n}}{{Dist}_{1} + {Dist}_{2} + ⋯ + {Dist}_{n}} \qquad ( 2 )$$

The shorter distance to the object affective word the adjacent affective word has, that is, the smaller the difference from the taste indicated by the object affective word the adjacent affective word has, the shorter the ratio (RateOfDist) of a distance with respect to the sum of the distances is.

Next, the contribution of each adjacent affective word relative to the taste indicated by the object affective word is calculated, according to the following Equation (3). n is the number of adjacent affective words.

$${Rate}_{1} = ( 1 - {RateOf Dist}_{1} ) \times α \\ {Rate}_{2} = ( 1 - {RateOf Dist}_{2} ) \times α \\ ⋯ \\ {Rate}_{n} = ( 1 - {RateOf Dist}_{n} ) \times α \\ {Rate}_{1} + {Rate}_{2} + ⋯ + {Rate}_{n} = 1 \\ a = \frac{1}{n - 1} \qquad ( 3 )$$

The calculated results are represented in the following Equation (4).

$${Rate}_{1} = \frac{{Dist}_{2} + {Dist}_{3} + ⋯ + {Dist}_{n}}{( {Dist}_{1} + {Dist}_{2} + ⋯ + {Dist}_{n} ) ( n - 1 )} \\ {Rate}_{2} = \frac{{Dist}_{1} + {Dist}_{3} + ⋯ + {Dist}_{n}}{( {Dist}_{1} + {Dist}_{2} + ⋯ + {Dist}_{n} ) ( n - 1 )} \\ ⋯ \\ {Rate}_{n} = \frac{{Dist}_{1} + {Dist}_{2} + ⋯ + {Dist}_{n - 1}}{( {Dist}_{1} + {Dist}_{2} + ⋯ + {Dist}_{n} ) ( n - 1 )} \qquad ( 4 )$$

The shorter the distance to the object affective word that the adjacent affective word has, that is, the smaller the difference from the taste indicated by the object affective word that the adjacent affective word has, the greater the contribution (Rate) is.

Next, the affective score of each design element relative to the taste indicated by the object affective word is calculated (estimated) according to the following Equation (5).

Kₜ_{_}CScoreₖ=Σᵢ₌₁ⁿ(Kᵢ_{_}CScoreₖ×Rateᵢ) (5)

k is the number for identifying a design element. Kᵢ_{_}CScoreₖ is the affective score of a design element k associated with the adjacent affective word. Kₜ_{_}CScoreₖ is the affective score of the design element k corresponding to the taste shown by the object affective word.

If the affective score of each design element for the taste indicated by the object affective word is calculated according to the above Equation (5), the design element having the highest affective score is selected as the applicable design element, for each design category, from among plural design elements. The object is designed by using the applicable design element.

Hereinafter, a specific example for the process by the design creation device 10 according to the present exemplary embodiment will be described. As an example, it is assumed to create the design of “Business card”. When creating the design, business card information (personal information of the user) displayed on the business card and the object affective word (taste) are input by the user, in the terminal device 12. The information is transmitted from the terminal device 12 to the design creation device 10 through the communication path N. Of course, the information may be directly input to the design creation device 10.

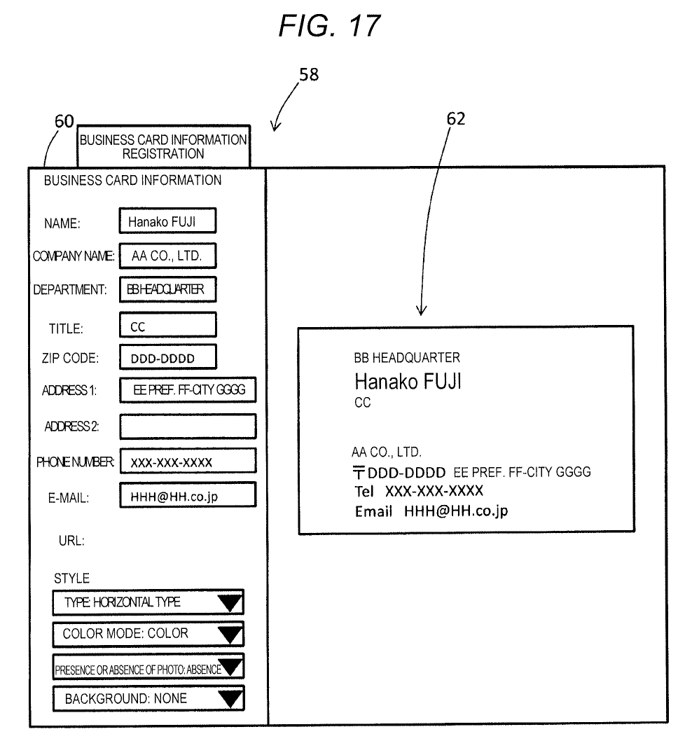

Here, a screen for inputting business card information will be described with reference to FIG. 17. FIG. 17 illustrates an example of the screen. A business card information registration screen 58 is a screen for inputting the business card information, and is displayed, for example, on the UI unit 34 of the terminal device 12. The business card information registration screen 58 includes an input field 60, and is configured such that the business card information (personal information) such as a name is input to the input field 60. If the business card information is input to the input field 60, the image 62 of the business card, in which the business card information is displayed, is displayed on the business card information registration screen 58. The image 62 is an image of a business card with a default design.

In a case where the information indicating the object affective word is stored in the affective evaluation DB 16, the object “Business card” is designed by using each conforming design element associated with the object affective word, in other words, a design element having a maximum affective score in each design category.

FIG. 18 illustrates an example of the design of the object “Business card” that is created by using the conforming design element. As an example, it is assumed that ┌ [symbol] ┘ (“Dynamic”) is designated by the user as the object affective word. In this case, the design is created by using each conforming design element associated with the object affective word ┌ [symbol] ┘ (“Dynamic”). For example, as illustrated in FIGS. 5 and 6, the conforming design element of the design category “(Template of) background” is “7: Thick diagonal line”, and the conforming design element of the design category “Distribution of character element” is “6: radiation”. The conforming design element is determined for other design categories. The image 64 of the business card of the design that gives a ┌ [symbol] ┘ (“Dynamic”) impression is generated by using these conforming design elements. The business card information that is input by the user is represented in the image 64. The data of the image 64 is transmitted, for example, from the design creation device 10 to the terminal device 12, and the image 64 is displayed on the UI unit 34 of the terminal device 12. The image 64 functions as, for example, a template, and may be edited by the user. For example, the font type, the character arrangement, the color, the design, the business card information, and the like are edited by the user.

Hereinafter, a description will be made regarding a case where the information indicating the object affective word that is designated by the user is not stored in the affective evaluation DB 16.

### Example 1

Hereinafter, Example 1 will be described. In Example 1, it is assumed that the object “Business card” is designed. In addition, it is assumed that the information indicating the object affective word that is designated by the user is not stored in the affective evaluation DB 16, and is stored in the relationship DB 18.

First, the business card information (personal information of the user) displayed on the business card and the object affective word (taste) are input by the user, in the terminal device 12. In addition, “Business card” is designated as the object of design creation. The information is transmitted from the terminal device 12 to the design creation device 10 through the communication path N. Of course, the information may be directly input to the design creation device 10. In Example 1, it is assumed that the affective word ┌ [symbol] ┘ (“Beautiful”) is designated by the user as the object affective word.

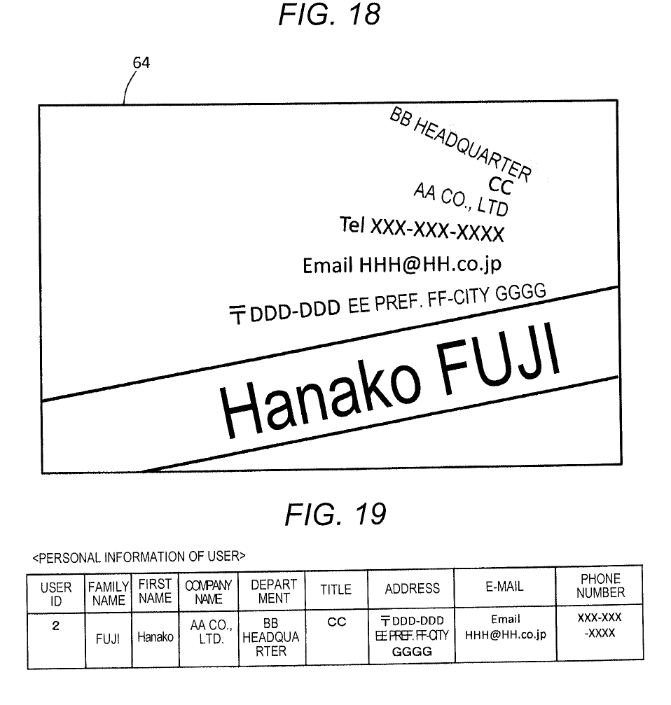

FIG. 19 illustrates an example of the input personal information (business card information). For example, a name, a company name, a department, a title, an address, an Email, a phone number, and the like are input as personal information.

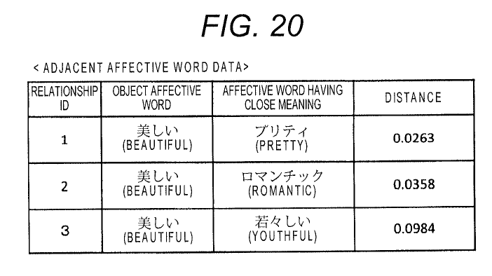

In a case where information indicating the object affective word ┌ [symbol] ┘ (“Beautiful”) is not stored in the affective evaluation DB 16 but is stored in the relationship DB 18, the taste calculation unit 24 extracts the adjacent affective word having the meaning close to the meaning of the object affective word ┌ [symbol] ┘ (“Beautiful”) from the relationship DB 18. For example, the taste calculation unit 24 extracts the adjacent affective word associated with the object affective word ┌ [symbol] ┘ (“Beautiful”) (the affective word having the close meaning), from the relationship table, with reference to the relationship table illustrated in FIG. 8. The affective word having a distance to the object affective word, which is a reference distance or less, may be extracted as the adjacent affective word. The reference distance is a preset value, and may be changed to any value by the user or the like. FIG. 20 illustrates an example of the extracted adjacent affective words. As an example, the affective words having a distance to the object affective word ┌ [symbol] ┘ (“Beautiful”), which is 0.1 or less, for example, affective words ┌ [symbol] ┘ (“Pretty”), ┌ [symbol] ┘ (“Romantic”), and ┌ [symbol] ┘ (“Youthful”) are extracted as the adjacent affective words.

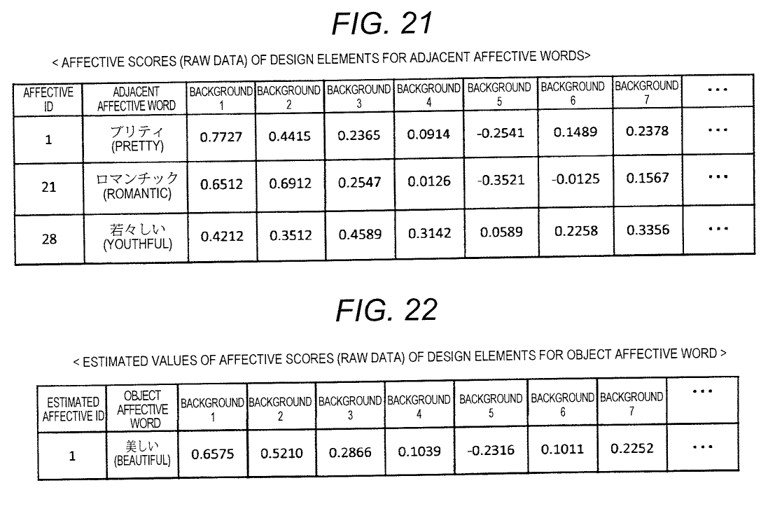

Next, the taste calculation unit 24 acquires the affective score raw data of each of the adjacent affective words ┌ [symbol] ┘ (“Pretty”), ┌ [symbol] ┘ (“Romantic”), and ┌ [symbol] [symbol] ┘ (“Youthful”), from the affective evaluation DB 16. FIG. 21 illustrates an example of the affective score raw data. The affective score raw data of each adjacent affective word includes the affective score of each design element belonging to each design category. Backgrounds 1, 2, 3, . . . are design elements belonging to the design category “Template of background”, and the affective score of each design element is obtained in advance. The affective score of each design element is obtained in advance, for other design categories, in the same manner.

Next, the taste calculation unit 24 calculates the contribution Rate of each adjacent affective word, according to the above Equation (4). The following Equation (6) is a specific calculation equation of each contribution. Rate₁ is the contribution of the adjacent affective word ┌ [symbol] ┘ (“Pretty”), Rate₂ is the contribution of the adjacent affective word ┌ [symbol] ┘ (“Romantic”), and Rate₃ is the contribution of the adjacent affective word ┌ [symbol] ┘ (“Youthful”). Dist₁ is a distance between the object affective word ┌ [symbol] ┘ (“Beautiful”) and the adjacent affective word ┌ [symbol] ┘ (“Pretty”), Dist₂ is a distance between the object affective word ┌ [symbol] ┘ (“Beautiful”) and the adjacent affective word ┌ [symbol] ┘ (“Romantic”), and Dist₃ is a distance between the object affective word ┌ [symbol] ┘ (“Beautiful”) and the adjacent affective word ┌ [symbol] ┘ (“Youthful”).

$${Rate}_{1} = \frac{{Dist}_{2} + {Dist}_{3}}{( {Dist}_{1} + {Dist}_{2} + {Dist}_{3} ) ( 3 - 1 )} = \frac{0.0358 + 0.0984}{( 0.0263 + 0.0358 + 0.0984 ) \times 2} = 0.4181 \\ {Rate}_{2} = \frac{{Dist}_{1} + {Dist}_{3}}{( {Dist}_{1} + {Dist}_{2} + {Dist}_{3} ) ( 3 - 1 )} = \frac{0.0263 + 0.0984}{( 0.0263 + 0.0358 + 0.0984 ) \times 2} = 0.3885 \\ {Rate}_{3} = \frac{{Dist}_{1} + {Dist}_{2}}{( {Dist}_{1} + {Dist}_{2} + {Dist}_{3} ) ( 3 - 1 )} = \frac{0.0263 + 0.0358}{( 0.0263 + 0.0358 + 0.0984 ) \times 2} = 0.1934 \qquad ( 6 )$$

Next, the taste calculation unit 24 calculates the affective score of each design element for the object affective word ┌ [symbol] ┘ (“Beautiful”), according to the above Equation (5), by using the contribution Rate of each adjacent affective word and the affective score of the design element associated with each adjacent affective word. For example, the affective score of the design element “Background 1” with respect to the object affective word ┌ [symbol] ┘ (“Beautiful”) is obtained as follows. The affective score of the design element “Background 1”=the affective score of “Background 1” of ┌ [symbol] [symbol] ┘ (“Pretty”)×contribution Rate₁ of ┌ [symbol] ┘ (“Pretty”)+the affective score of “Background 1” of ┌ [symbol] ┘ (“Romantic”)×contribution Rate₂ of ┌ [symbol] ┘ (“Romantic”)+the affective score of “Background 1” of ┌ [symbol] [symbol] ┘ (“Youthful”)×contribution Rate₃ of ┌ [symbol] ┘ (“Youthful”)=0.7727×0.4181+0.6512×0.3885+0.4212×0.1934=0.6575

As described above, the affective score of each design element belonging to each design category is calculated (estimated) with respect to the object affective word ┌ [symbol] [symbol] ┘ (“Beautiful”), and thus the affective score raw data for the object affective word ┌ [symbol] ┘ (“Beautiful”) is calculated (estimated).

FIG. 22 illustrates an example of the calculated (estimated) affective score raw data. The affective score raw data for the object affective word [symbol] (“Beautiful”) includes the affective score of each design element belonging to each design category. Each affective score is a value that is calculated according to the above Equation (5). FIG. 22 illustrates the affective score of design elements “backgrounds 1, 2, 3, . . . ” belonging to the design category “Template of background”. The affective score of each design element is calculated similarly to other design categories.

Next, the taste calculation unit 24 determines the conforming design element that conforms to the object affective word ┌ [symbol] ┘ (“Beautiful”), based on the affective score raw data for the object affective word ┌ [symbol] ┘ (“Beautiful”). Specifically, the taste calculation unit 24 selects a design element having the highest affective score (maximum design element) for each design category, from among plural design elements. Then, the taste calculation unit 24 employs a design element having an affective score closest to the maximum design element, from among the plural design elements that are defined in the affective score raw data of each taste, for each design category, as the conforming design element for the object affective word, by referring to the affective score raw data for each taste (affective word) that is stored in the affective evaluation DB 16. For example, the affective score (0.6575) of the design element “Background 1” is highest among plural design elements (Backgrounds 1, 2, 3, . . . ) belonging to the design category “(Template of) background”. Therefore, the design element “Background 1” is selected as the maximum design element for the design category “(Template of) background”. Then, the design element having an affective score that is closest to the affective score (0.6575) of the maximum design element “Background 1” in the affective score raw data of each taste (affective word) is employed as the conforming design element for the design category “(Template of) background” among plural design elements belonging to the design category “(Template of) background”. The conforming design element is determined for each design category, and thus the affective evaluation data for the object affective word ┌ [symbol] ┘ (“Beautiful”) is calculated (estimated).

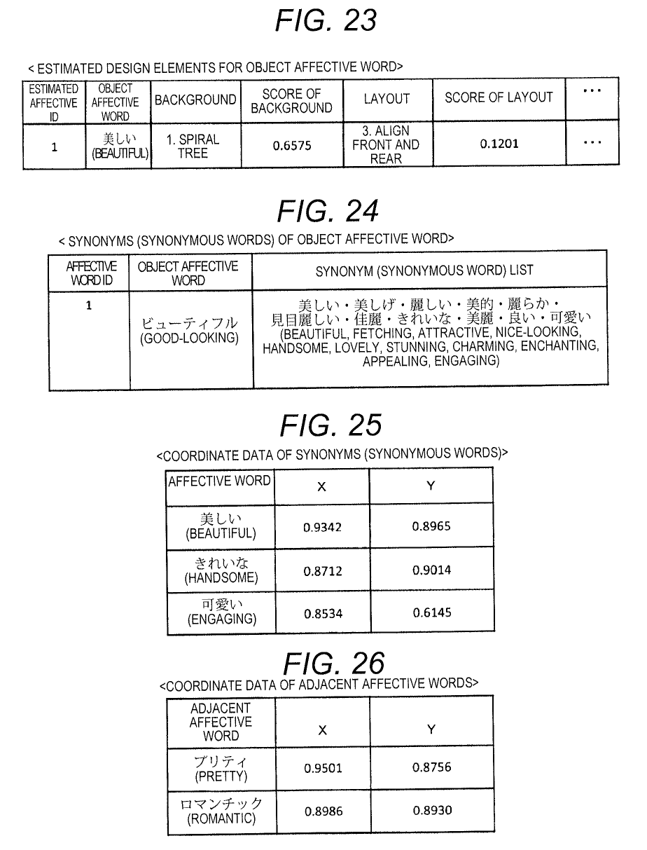

FIG. 23 illustrates an example of the affective evaluation table as the calculated (estimated) affective evaluation data. As illustrated in FIG. 22, since the affective score (0.6575) of the design element “Background 1” is the maximum with respect to the design category “(Template of) background”, the design element having the affective score that is closest to the affective score (0.6575) is employed as the conforming design element. Specifically, since the affective score of the design element “1. Spiral tree” is 0.6575, the design element “1. Spiral tree” is employed as the conforming design element. The conforming design elements are also determined for other design categories, in the same manner.

If the affective evaluation data for the object affective word ┌ [symbol] ┘ (“Beautiful”) is calculated (estimated), the design creation unit 26 generates data indicating the design of the object “Business card” (for example, the image data, the template data, and the like of “Business card”), by using each conforming design element included in the affective evaluation data. The data is transmitted from the design creation device 10 to the terminal device 12, and the image, the template, and the like of “Business card” are displayed on the UI unit 34 of the terminal device 12. The design and the business card information of the business card may be edited in the terminal device 12.

Through the above process, in a case where the object affective word that is designated by the user is not stored in the affective evaluation DB 16, and the object affective word is stored in the relationship DB 18, the object is designed by performing interpolation using each design element that is associated with the adjacent affective word. Thus, even in a case where the conforming design element for the object affective word is not determined in advance, the conforming design element for the object affective word is estimated, and the design having a taste which is the same as or close to the taste indicated by the object affective word is created. The adjacent affective word has a meaning (taste) closer to the object affective word, as compared to other affective words. Therefore, since the object is designed by performing interpolation using the conforming design element of the adjacent affective word, the design having a taste that is closer to the taste indicated by the object affective word is created, as compared to the case of using the conforming design element of the affective word other than the adjacent affective word.

### Example 2

Hereinafter, Example 2 will be described. In Example 2, it is assumed that the object “Business card” is designed. In addition, it is assumed that the information indicating the object affective word that is designated by the user is not stored in any of the affective evaluation DB 16 and the relationship DB 18.

First, the business card information (personal information of the user) and the object affective word (taste) are input by the user. In addition, “Business card” is designated as the object of design creation. In Example 2, it is assumed that the affective word ┌ [symbol] ┘ (“Good-looking”) is designated by the user as the object affective word. The personal information of the user (business card information) is, for example, the same as the information illustrated in FIG. 19.

In a case where information indicating the object affective word ┌ [symbol] ┘ (“Good-looking”) is not stored in any of the affective evaluation DB 16 and the relationship DB 18, the taste calculation unit 24 searches the synonym DB for the object affective word ┌ [symbol] ┘ (“Good-looking”), and extracts the synonym (synonymous term) of the object affective word ┌ [symbol] ┘ (“Good-looking”) from the synonym DB 22. For example, the taste calculation unit 24 extracts the synonym (synonymous term) of the object affective word ┌ [symbol] ┘ (“Good-looking”), with reference to the synonym table illustrated in FIG. 10.

FIG. 24 illustrates an example of the synonym (synonymous term) of the object affective word ┌ [symbol] ┘ (“Good-looking”). The taste calculation unit 24 extracts plural synonyms from the synonym list. As an example, three synonyms (for example, ┌ [symbol] ┘ (“Beautiful”), ┌ [symbol] ┘ (“Handsome”), ┌ [symbol] ┘ (“Lovely”) that have been registered in the relationship DB 18 are extracted. FIG. 25 illustrates the coordinates of the synonym on the image map.

Next, the taste calculation unit 24 determines the temporary coordinates of the object affective word ┌ [symbol] [symbol] ┘ (“Good-looking”) on the image map, by using the three synonyms. Specifically, the taste calculation unit 24 makes a circle including the coordinates of the three synonyms on the image map, and estimates the center coordinates of the circle, as the temporary coordinates of the object affective word ┌ [symbol] ┘ (“Good-looking”). Next, the taste calculation unit 24 specifies the affective word (adjacent affective word) which is associated with the coordinate adjacent to the temporary coordinate. For example, the affective word that is closest to the temporary coordinate and the affective word that is second closest thereto are selected as the adjacent affective words. As an example, it is assumed that affective words ┌ [symbol] ┘ (“Pretty”) and ┌ [symbol] ┘ (“Romantic”) are selected as the adjacent affective words. FIG. 26 illustrates the coordinates of the adjacent affective words. In addition, three or more adjacent affective words may be selected.

Next, the taste calculation unit 24 acquires the affective score raw data of each adjacent affective word, calculates the contribution Rate of each adjacent affective word according to the above Equation (4), and calculates the affective score of each design element according to the above Equation (5), similarly to Example 1. Thus, the affective score raw data for the object affective word ┌ [symbol] ┘ (“Good-looking”) is calculated (estimated). The taste calculation unit 24 determines the conforming design element that conforms to the object affective word ┌ [symbol] ┘ (“Good-looking”), based on the affective score raw data. Thus, the affective evaluation data for the object affective word ┌ [symbol] ┘ (“Good-looking”) is calculated (estimated). The design creation unit 26 generates the data (image data, template data, and the like) indicating the design of the object “Business card”, by using each conforming design element that is included in the affective evaluation data. The data is transmitted from the design creation device 10 to the terminal device 12, and the image, the template, and the like of the business card are displayed on the UI unit 34 of the terminal device 12.

Through the above process, in a case where the object affective word which is designated by the user is not stored in any of the affective evaluation DB 16 and the relationship DB 18, the object is designed by selecting the adjacent affective word based on the synonym (synonymous term) of the object affective word, and performing interpolation using each design element associated with the adjacent affective word. Thus, even in a case where the conforming design element for the object affective word is not generated in advance, and the adjacent affective word for the object affective word is not defined in advance, design with the same taste as or a taste close to the taste indicated by the object affective word is created. The synonym (synonymous term) of the object affective word has the same as or close meaning (taste) as or to the object affective word. Therefore, as compared to the case of using the affective word other than the synonym (synonymous term), design having a taste which is closer to the taste indicated by the object affective word, by using the synonym (synonymous term) is created.

### Example 3

Hereinafter, Example 3 will be described. In Example 3, the preferable object affective word and the unpreferable object affective word are designated by the user. A preferable object affective word indicates the taste of a target design, and an unpreferable object affective word indicates the taste which does not conforming the target design, in other words, the taste to be excluded. In Example 3, it is assumed that the object “Business card” is designed. In addition, it is assumed that the information indicating the object affective word that is designated by the user is not stored in the affective evaluation DB 16, and is stored in the relationship DB 18.

First, business card information (personal information of the user), preferable object affective word, and unpreferable object affective word (affective information to be excluded) are input by the user, in the terminal device 12. In addition, “Business card” is designated as the object of design creation. In Example 3, it is assumed that ┌ [symbol] ┘ (“Beautiful”) is designated as the preferable object affective word, and ┌ [symbol] ┘ (“Cute”) is designated as the unpreferable object affective word. The personal information (business card information) of the user is the same as, for example, the information illustrated in FIG. 19.

In a case where information indicating the object affective words ┌ [symbol] ┘ (“Beautiful”) and ┌ [symbol] ┘ (“Cute”) is not stored in the affective evaluation DB 16, but is stored in the relationship DB 18, the taste calculation unit 24 extracts the adjacent affective word having a meaning close to the meaning of the preferable object affective word ┌ [symbol] [symbol] ┘ (“Beautiful”) from the relationship DB 18, and extracts the adjacent affective word having a meaning close to the meaning of the unpreferable object affective word ┌ [symbol] ┘ (“Cute”) from the relationship DB 18. For example, the taste calculation unit 24 extracts adjacent affective words (affective word having close meaning) associated with the preferable object affective word ┌ [symbol] ┘ (“Beautiful”) and the adjacent affective words associated with the unpreferable object affective word ┌ [symbol] ┘ (“Cute”), from the relationship table, by referring to the relationship table illustrated in FIG. 8. For example, the affective words having a distance to the object affective word, which is a reference distance or less, are extracted as the adjacent affective words.

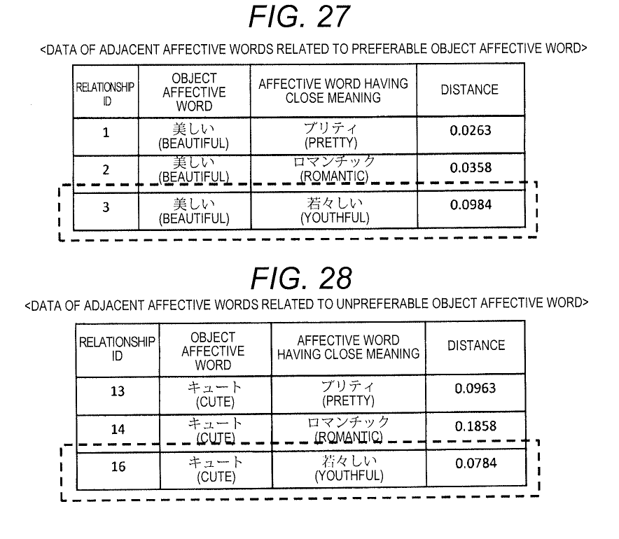

FIG. 27 illustrates an example of the adjacent affective word having a meaning close to the meaning of the preferable object affective word ┌ [symbol] ┘ (“Beautiful”). FIG. 28 illustrates an example of the adjacent affective word having a meaning close to the meaning of the unpreferable object affective word ┌ [symbol] ┘ (“Cute”). As an example, the affective words having a distance to the object affective words ┌ [symbol] ┘ (“Beautiful”), or ┌ [symbol] ┘ (“Cute”), which is 0.1 or less, are extracted as the adjacent affective word. Specifically, ┌ [symbol] ┘ (“Pretty”), ┌ [symbol] ┘ (“Romantic”), and ┌ [symbol] ┘ (“Youthful”) are extracted as the adjacent affective words related to the preferable object affective word, and ┌ [symbol] ┘ (“Pretty”), ┌ [symbol] ┘ (“Romantic”), and ┌ [symbol] ┘ (“Youthful”) are extracted as the adjacent affective words related to the unpreferable object affective word.

The taste calculation unit 24 compares the distance of the adjacent affective word group related to the preferable object affective word, with the distance of the adjacent affective word group related to the unpreferable object affective word, and extracts the adjacent affective word having the distance to the preferable object affective word ┌ [symbol] [symbol] ┘ (“Beautiful”) being shorter than the distance to the unpreferable object affective word ┌ [symbol] ┘ (“Cute”), as the adjacent affective word for calculation. In the examples of FIGS. 27 and 28, the distances between the preferable object affective word ┌ [symbol] ┘ (“Beautiful”) and the affective words ┌ [symbol] ┘ (“Pretty”) and ┌ [symbol] ┘ (“Romantic”) are shorter than the distances between the unpreferable object affective word ┌ [symbol] ┘ (“Cute”) and the affective words ┌ [symbol] [symbol] ┘ (“Pretty”) and ┌ [symbol] ┘ (“Romantic”). Therefore, the affective words ┌ [symbol] ┘ (“Pretty”) and ┌ [symbol] ┘ (“Romantic”) are extracted as the adjacent affective words for calculation. Meanwhile, the distance between the preferable object affective word ┌ [symbol] ┘ (“Beautiful”) and the affective word ┌ [symbol] ┘ (“Youthful”) is longer than the distance between the unpreferable object affective word ┌ [symbol] ┘ (“Cute”) and the affective word ┌ [symbol] ┘ (“Youthful”). Therefore, the affective words rah ┌ [symbol] ┘ (“Youthful”) is not extracted as the adjacent affective word for calculation.

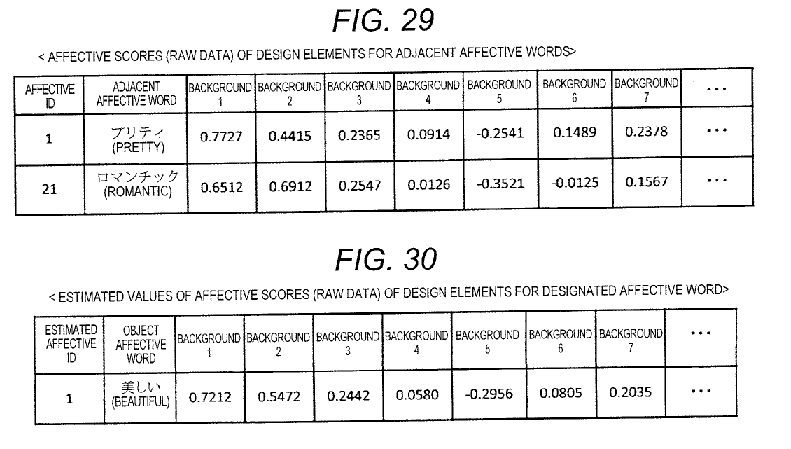

Next, the taste calculation unit 24 acquires the affective score raw data of each of the adjacent affective words for calculation ┌ [symbol] ┘ (“Pretty”) and ┌ [symbol] ┘ (“Romantic”), from the affective evaluation DB 16. FIG. 29 illustrates an example of the affective score raw data. The affective score raw data of each adjacent affective word for calculation includes the affective score of each design element belonging to each design category. Backgrounds 1, 2, 3, . . . are design elements belonging to the design category “Template of background”, and the affective score of each design element is obtained in advance. The affective score of each design element is obtained in advance, for other design categories, in the same manner.

Next, the taste calculation unit 24 calculates the contribution Rate of each adjacent affective word for each calculation, according to the above Equation (4), similarly to Example 1. The following Equation (7) is a specific calculation equation of each contribution. Rate₁ is the contribution of the adjacent affective word ┌ [symbol] ┘ (“Pretty”) and Rate₂ is the contribution of the adjacent affective word ┌ [symbol] ┘ (“Romantic”). Dist₁ is a distance between the preferable object affective word ┌ [symbol] ┘ (“Beautiful”) and the adjacent affective word ┌ [symbol] ┘ (“Pretty”), and Dist₂ is a distance between the preferable object affective word ┌ [symbol] ┘ (“Beautiful”) and the adjacent affective word ┌ [symbol] ┘ (“Romantic”).

$${Rate}_{1} = \frac{{Dist}_{2}}{( {Dist}_{1} + {Dist}_{2} ) ( 2 - 1 )} = \frac{0.0358}{( 0.0263 + 0.0358 )} = 0.5765 \\ {Rate}_{2} = \frac{{Dist}_{1}}{( {Dist}_{1} + {Dist}_{2} ) ( 2 - 1 )} = \frac{0.0263}{( 0.0263 + 0.0358 )} = 0.4235 \qquad ( 7 )$$

Next, the taste calculation unit 24 calculates the affective score of each design element for the preferable object affective word ┌ [symbol] ┘ (“Beautiful”), according to the above Equation (5), by using the contribution Rate of each adjacent affective word and the affective score of the design element associated with each adjacent affective word. For example, the affective score of the design element “Background 1” with respect to the preferable object affective word ┌ [symbol] [symbol] ┘ (“Beautiful”) is obtained as follows. The affective score of the design element “Background 1”=the affective score of “Background 1” of ┌ [symbol] ┘ (“Pretty”)×contribution Rate₁ of ┌ [symbol] ┘ (“Pretty”)+the affective score of “Background 1” of ┌ [symbol] ┘ (“Romantic”)×contribution Rate₂ of ┌ [symbol] ┘ (“Romantic”)=0.7727×0.5765+0.6512×0.4235=0.7212

In this manner, with respect to the preferable object affective word ┌ [symbol] ┘ (“Beautiful”), the affective score of each design element belonging to each design category is calculated (estimated), and thus the affective score raw data for the preferable object affective word ┌ [symbol] ┘ (“Beautiful”) is calculated (estimated).

FIG. 30 illustrates an example of the calculated (estimated) affective score raw data. The affective score raw data for the preferable object affective word ┌ [symbol] ┘ (“Beautiful”) includes the affective score of each design element belonging to each design category. Each affective score is a value that is calculated according to the above Equation (5). FIG. 30 illustrates the affective scores of the design elements “Background 1, 2, 3, . . . ” belonging to the design category “Template of background”. The affective score of each design element is calculated for other design categories, in the same manner.

Next, similarly to Example 1, the taste calculation unit 24 determines the conforming design element to be applied to the preferable object affective word ┌ [symbol] ┘ (“Beautiful”), based on the affective score raw data for the preferable object affective word ┌ [symbol] ┘ (“Beautiful”). Specifically, the taste calculation unit 24 selects a design element having the highest affective score (maximum design element) for each design category, from among plural design elements. Then, the taste calculation unit 24 employs a design element having an affective score closest to the maximum design element, from among the plural design elements that are defined in the affective score raw data of each taste, for each design category, as the applicable design element of the preferable object affective word ┌ [symbol] ┘ (“Beautiful”), by referring to the affective score raw data for each taste (affective word) that is stored in the affective evaluation DB 16. For example, the affective score (0.7212) of the design element “Background 1” is highest among plural design elements (Backgrounds 1, 2, 3, . . . ) belonging to the design category “(Template of) background”. Therefore, the design element “Background 1” is selected as the maximum design element for the design category “(Template of) background”. Then, the design element having an affective score that is closest to the affective score (0.7212) of the maximum design element “Background 1” in the affective score raw data of each taste (affective word) is employed as the conforming design element for the design category “(Template of) background” from among plural design elements belonging to the design category “(Template of) background”. The conforming design element is determined for each design category, and thus the affective evaluation data for the preferable object affective word ┌ [symbol] ┘ (“Beautiful”) is calculated (estimated).

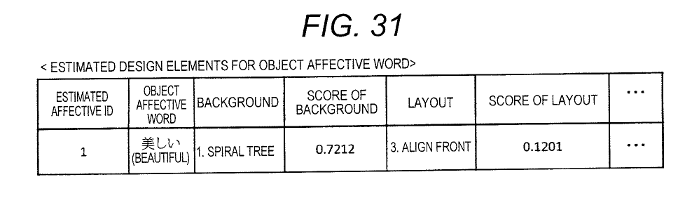

FIG. 31 illustrates an example of the affective evaluation table as the calculated (estimated) affective evaluation data. As illustrated in FIG. 30, since the affective score (0.7212) of the design element “Background 1” is maximum with respect to the design category “(Template of) background”, the design element having the affective score that is closest to the affective score (0.7212) is employed as the conforming design element. The conforming design elements are also determined for other design categories, in the same manner.

If the affective evaluation data for the preferable object affective word ┌ [symbol] ┘ (“Beautiful”) is calculated (estimated), the design creation unit 26 generates data having the design of the object “Business card” (for example, the image data, the template data, and the like of “Business card”), by using each conforming design element included in the affective evaluation data. The data is transmitted from the design creation device 10 to the terminal device 12, and the image, the template, and the like of the business card are displayed on the UI unit 34 of the terminal device 12.

Through the above process, the object is designed, by excluding the adjacent affective word in which a distance to the unpreferable object affective word is shorter than a distance to the preferable object affective word, and performing interpolation using each design element that is associated with the adjacent affective word that is not excluded. Accordingly, as compared with the case where the adjacent affective word having a shorter distance to the unpreferable object affective word is not excluded, design having a closer taste to the taste indicated by the preferable object affective word is created. In the case where the adjacent affective word having a shorter distance to the unpreferable object affective word is not excluded, the design element associated with the unpreferable object affective word gives an effect, and thus design having a taste that is correspondingly away from the target design may be created. According to Example 3, since the influence is excluded, design that is closer to the target design is created.

### Example 4

Hereinafter, Example 4 will be described. Although the business card is designed in the above Examples 1 to 3, the present exemplary embodiment may be applied to an object other than the document. In Example 4, as an example, it is assumed that clothes (specifically, an overcoat) is designed. In addition, it is assumed that the information indicating the object affective word that is designated by the user is not stored in the affective evaluation DB 16 and is stored in the relationship DB 18. The process according to Example 4 is the same as the process according to Example 1

First, the object affective word (taste) is input by the user, in the terminal device 12. In addition, “Clothes (overcoat)” is designated as the object of design creation. The input information is transmitted from the terminal device 12 to the design creation device 10 through the communication path N. Of course, the information may be directly input to the design creation device 10. In Example 4, it is assumed that the affective word ┌ [symbol] ┘ (“Sporty”) is designated by the user as the object affective word.

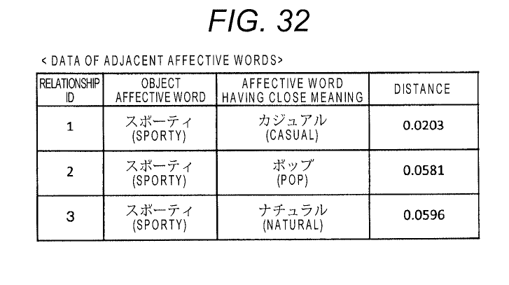

In a case where information indicating the object affective word ┌ [symbol] ┘ (“Sporty”) is not stored in the affective evaluation DB 16, but is stored in the relationship DB 18, the taste calculation unit 24 extracts the adjacent affective word having the meaning close to the meaning of the object affective word ┌ [symbol] ┘ (“Sporty”) from the relationship DB 18. For example, the taste calculation unit 24 extracts the adjacent affective word associated with the object affective word ┌ [symbol] ┘ (“Sporty”), from the relationship table, with reference to the relationship table illustrated in FIG. 12. The affective word having a distance to the object affective word, which is a reference distance or less, may be extracted as the adjacent affective word. FIG. 32 illustrates an example of the extracted adjacent affective word. As an example, the affective word having a distance to the object affective word ┌ [symbol] ┘ (“Sporty”) being 0.1 or less, for example, the affective words ┌ [symbol] ┘ (“Casual”), ┌ [symbol] ┘ (“Pop”), and ┌ [symbol] ┘ (“Natural”) are extracted as the adjacent affective words.

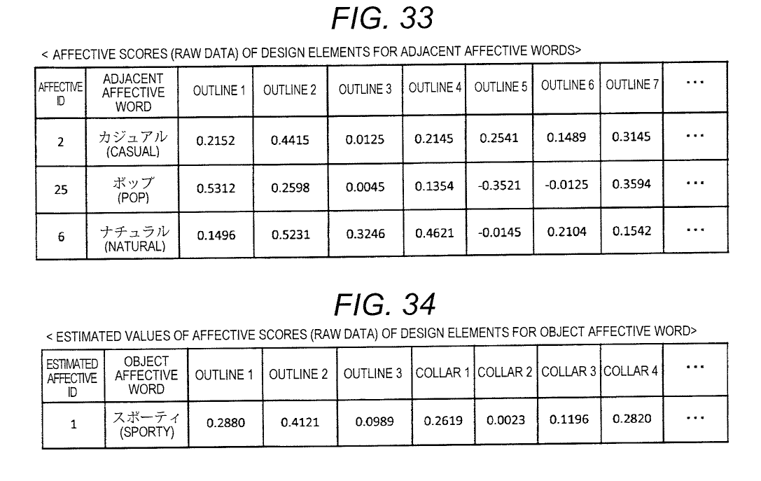

Next, the taste calculation unit 24 acquires the affective score raw data of each of the adjacent affective words ┌ [symbol] ┘ (“Casual”), ┌ [symbol] ┘ (“Pop”), and ┌ [symbol] ┘ (“Natural”), from the affective evaluation DB 16. FIG. 33 illustrates an example of the affective score raw data. The affective score raw data of each adjacent affective word includes the affective score of each design element belonging to each design category. The outlines 1, 2, 3 are design elements belonging to the design category “Outline of (clothes)”, and collars 1, 2, 3, . . . are design elements belonging to the design category “collar (of clothes)”. The affective score of each design element is obtained in advance. The affective score of each design element is obtained in advance for other design categories in the same manner.

Next, the taste calculation unit 24 calculates the contribution Rate of each adjacent affective word, according to the above Equation (4). The following Equation (8) is a specific calculation equation of each contribution. Rate₁ is the contribution of the adjacent affective word ┌ [symbol] ┘ (“Casual”), Rate₂ is the contribution of the adjacent affective word ┌ [symbol] ┘ (“Pop”), and Rate₃ is the contribution of the adjacent affective word ┌ [symbol] ┘ (“Natural”). Dist₁ is a distance between the object affective word ┌ [symbol] ┘ (“Sporty”) and the adjacent affective word ┌ [symbol] ┘ (“Casual”), Dist₂ is a distance between the object affective word ┌ [symbol] ┘ (“Sporty”) and the adjacent affective word ┌ [symbol] ┘ (“Pop”), and Dist₃ is a distance between the object affective word ┌ [symbol] ┘ (“Sporty”) and the adjacent affective word ┌ [symbol] ┘ (“Natural”).

$${Rate}_{1} = \frac{{Dist}_{2} + {Dist}_{3}}{( {Dist}_{1} + {Dist}_{2} + {Dist}_{3} ) ( 3 - 1 )} = \frac{0.0581 + 0.0596}{( 0.0203 + 0.0581 + 0.0596 ) \times 2} = 0.4264 \\ {Rate}_{2} = \frac{{Dist}_{1} + {Dist}_{3}}{( {Dist}_{1} + {Dist}_{2} + {Dist}_{3} ) ( 3 - 1 )} = \frac{0.0203 + 0.0596}{( 0.0203 + 0.0581 + 0.0596 ) \times 2} = 0.2895 \\ {Rate}_{3} = \frac{{Dist}_{1} + {Dist}_{2}}{( {Dist}_{1} + {Dist}_{2} + {Dist}_{3} ) ( 3 - 1 )} = \frac{0.0203 + 0.0581}{( 0.0203 + 0.0581 + 0.0596 ) \times 2} = 0.2841 \qquad ( 8 )$$

Next, the taste calculation unit 24 calculates the affective score of each design element for the object affective word ┌ [symbol] ┘ (“Sporty”), according to the above Equation (5), by using the contribution Rate of each adjacent affective word and the affective score of the design element associated with each adjacent affective word. For example, the affective score of the design element “Outline 1” with respect to the object affective word ┌ [symbol] ┘ (“Sporty”) is obtained as follows. The affective score of the design element “Outline 1”=the affective score of “Outline 1” of ┌ [symbol] ┘ (“Casual”)×contribution Rate₁ of ┌ [symbol] ┘ (“Casual”)+the affective score of “Outline 1” of ┌ [symbol] ┘ (“Pop”)×contribution Rate₂ of ┌ [symbol] ┘ (“Pop”)+the affective score of “Outline 1” of ┌ [symbol] ┘ (“Natural”)×contribution Rate₃ of ┌ [symbol] ┘ (“Natural”)=0.2152×0.4264+0.5312×0.2895+0.1496×0.2841=0.2880

In this manner, with respect to the object affective word ┌ [symbol] ┘ (“Sporty”), the affective score of each design element belonging to each design category is calculated (estimated), and thus the affective score raw data for the object affective word ┌ [symbol] ┘ (“Sporty”) is calculated (estimated).

FIG. 34 illustrates an example of the calculated (estimated) affective score raw data. The affective score raw data for the object affective word ┌ [symbol] ┘ (“Sporty”) includes the affective score of each design element belonging to each design category. Each affective score is a value that is calculated according to the above Equation (5). FIG. 34 illustrates the affective scores of the design elements “Outlines 1, 2, 3, . . . ” belonging to the design category “Outline of (clothes)”, and the affective scores of the design elements “Collars 1, 2, 3, . . . ” belonging to the design category “Collar (of clothes)”. The affective score of each design element is calculated for other design categories, in the same manner.

Next, the taste calculation unit 24 determines the conforming design element that conforms to the object affective word ┌ [symbol] ┘ (“Sporty”), based on the affective score raw data for the object affective word ┌ [symbol] ┘ (“Sporty”). Specifically, the taste calculation unit 24 selects a design element having the highest affective score (maximum design element) for each design category, from among plural design elements. Then, the taste calculation unit 24 employs a design element having an affective score closest to the maximum design element, from among the plural design elements that are defined in the affective score raw data of each taste, for each design category, as the conforming design element of the object affective word ┌ [symbol] ┘ (“Sporty”), by referring to the affective score raw data for each taste (affective word) that is stored in the affective evaluation DB 16. For example, the affective score (0.4121) of the design element “Outline 2” is highest among plural design elements (Outlines 1, 2, 3) belonging to the design category “Outline of (clothes)”. Therefore, the design element “Outline 2” is selected as the maximum design element for the design category “Outline of (clothes)”. Then, the design element having an affective score that is closest to the affective score (0.4121) of the maximum design element “Outline 2” in the affective score raw data of each taste (affective word) is employed as the conforming design element for the design category “Outline of (clothes)” from among plural design elements belonging to the design category “Outline of (clothes)”. The conforming design element is determined for each design category, and thus the affective evaluation data for the object affective word ┌ [symbol] [symbol] ┘ (“Sporty”) is calculated (estimated).

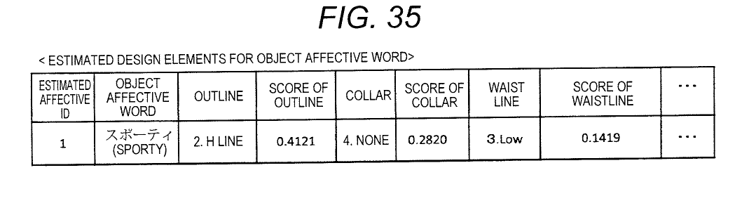

FIG. 35 illustrates an example of the affective evaluation table as the calculated (estimated) affective evaluation data. As illustrated in FIG. 34, since the affective score (0.412) of the design element “Outline 2” is maximum with respect to the design category “Outline of (clothes)”, the design element having the affective score that is closest to the affective score (0.412) is employed as the conforming design element. Specifically, since the affective score of the design element “2. H line” is 0.4121, the design element “2. H line” is employed as the applicable design element. The conforming design elements are also determined for other design categories, in the same manner.

If the affective evaluation data for the object affective word ┌ [symbol] ┘ (“Sporty”) is calculated (estimated), the design creation unit 26 generates data indicating the design of the object “Clothes (overcoat)” (for example, the image data, the template data, and the like of “overcoat”), by using each conforming design element included in the affective evaluation data. The data is transmitted from the design creation device 10 to the terminal device 12, and the image, the template, and the like of the overcoat are displayed on the UI unit 34 of the terminal device 12. In the terminal device 12, the design of the overcoat may be edited.

Through the above process, even in a case of designing an object other than a document, the object is designed by performing interpolation using each design element associated with the adjacent affective word. Thus, even in a case where the conforming design element for the object affective word is not defined in advance, design with the same taste as or a taste close to the taste indicated by the object affective word is created.

In addition, in a case where information indicated by the object affective word is stored in the affective evaluation DB 16, the object “Clothes (overcoat)” is designed, by using each conforming design element associated with the object affective word (see FIG. 11), in other words, the design element with the maximum affective score for each design category.

### Example 5

Hereinafter, Example 5 will be described. In Example 5, it is assumed that the object “Clothes (overcoat)” is designed. In addition, it is assumed that the information indicating the object affective word that is designated by the user is not stored in any of the affective evaluation DB 16 and the relationship DB 18. The process related to the Example 5 is the same as the process related to the Example 2.

First, the user inputs an object affective word (taste). Further, “Clothes (overcoat)” is designated as an object of design creation. In Example 5, it is assumed that the affective word ┌ [symbol] ┘ (“Easy”) is designated by the user as the object affective word.

In a case where information indicating the object affective word ┌ [symbol] ┘ (“Easy”) is not stored in any of the affective evaluation DB 16 and the relationship DB 18, the taste calculation unit 24 searches the synonym DB 22 for the object affective word ┌ [symbol] ┘ (“Easy”), and extracts the synonym (synonymous term) of the object affective word ┌ [symbol] ┘ (“Easy”) from the synonym DB 22. For example, the taste calculation unit 24 extracts the synonym (synonymous term) of the object affective word ┌ [symbol] ┘ (“Easy”), by referring to the synonym table illustrated in FIG. 14.

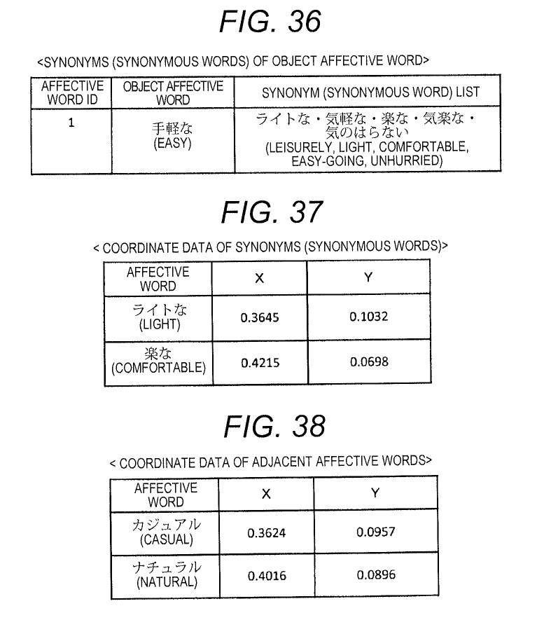

FIG. 36 illustrates an example of the synonym (synonymous term) of the object affective word ┌ [symbol] ┘ (“Easy”). The taste calculation unit 24 extracts plural synonyms from the synonym list. As an example, two synonyms (for example, ┌ [symbol] [symbol] ┘ (“Light”) and ┌ [symbol] ┘ (“Comfortable”)) that are registered in the relationship DB 18 are extracted. FIG. 37 illustrates the coordinates of the synonyms on the image map.

Next, the taste calculation unit 24 determines the temporary coordinates of the object affective word ┌ [symbol] ┘ (“Easy”), on the image map, by using two synonyms. Specifically, the taste calculation unit 24 makes a circle including the coordinates of two synonyms on the image map, and estimates the center coordinates of the circle as the temporary coordinates of the object affective word ┌ [symbol] ┘ (“Easy”). Next, the taste calculation unit 24 specifies the affective word (adjacent affective word) adjacent to the temporary coordinate. For example, the affective word that is closest to the temporary coordinate, and the affective word that is second closest thereto are selected as the adjacent affective words. As an example, it is assumed that affective words ┌ [symbol] ┘ (“Casual”) and ┌ [symbol] ┘ (“Natural”) are selected as the adjacent affective words. FIG. 38 illustrates the coordinates of the adjacent affective words. In addition, three or more adjacent affective words may be selected.

Next, similarly to Example 4, the taste calculation unit 24 acquires the affective score raw data of each adjacent affective word, calculates the contribution Rate of each adjacent affective word according to the above Equation (4), and calculates the affective score of each design element according to the above Equation (5). Thus, the affective score raw data for the object affective word ┌ [symbol] ┘ (“Easy”) is calculated (estimated). The taste calculation unit 24 determines a conforming design element that conforms to the object affective word ┌ [symbol] ┘ (“Easy”), based on the affective score raw data. Thus, the affective evaluation data for the object affective word ┌ [symbol] ┘ (“Easy”) is calculated (estimated). The design creation unit 26 generates data (image data, template data, and the like) indicating the design of the object “Clothes (overcoat)”, by using each design element that is included in the affective evaluation data. The data is transmitted from the design creation device 10 to the terminal device 12, and the image, the template, and the like of Clothes (overcoat) are displayed on the UI unit 34 of the terminal device 12.

Through the above process, even in a case of designing an object other than a document, the object is designed by selecting the adjacent affective word based on the synonym (synonymous term) of each object affective word, and performing interpolation using each design element associated with the adjacent affective word. Thus, even in a case where the conforming design element for the object affective word is not created in advance, and the adjacent affective word for the object affective word is not defined in advance, design with the same taste as or a taste close to the taste indicated by the object affective word is created.

### Example 6

Hereinafter, Example 6 will be described. In Example 6, it is assumed that the object “Clothes (overcoat)” is designed. In addition, it is assumed that plural object affective words are designated by the user, and the information is not stored in any of the affective evaluation DB 16 and the relationship DB 18.

First, the user inputs an object affective word (taste). Further, “Clothes (overcoat)” is designated as an object of design creation. In Example 6, it is assumed that the affective words ┌ [symbol] ┘ (“Easy”) and ┌ [symbol] ┘ (“Girlish”) are designated by the user as the object affective words.

In a case where information indicating the object affective word ┌ [symbol] ┘ (“Easy”) is not stored in any of the affective evaluation DB 16 and the relationship DB 18, the taste calculation unit 24 searches the synonym DB 22 for the object affective word ┌ [symbol] ┘ (“Easy”), and extracts the synonym of the object affective word ┌ [symbol] ┘ (“Easy”) from the synonym DB 22. Similarly, in a case where information indicating the object affective word ┌ [symbol] ┘ (“Girlish”) is not stored in any of the affective evaluation DB 16 and the relationship DB 18, the synonym of the object affective word ┌ [symbol] [symbol] ┘ (“Girlish”) is extracted from the synonym DB 22. For example, the taste calculation unit 24 extracts the synonym (synonymous term) of the object affective word ┌ [symbol] ┘ (“Easy”) and the synonym (synonymous term) of the object affective word ┌ [symbol] ┘ (“Girlish”), by referring to the synonym table illustrated in FIG. 14.

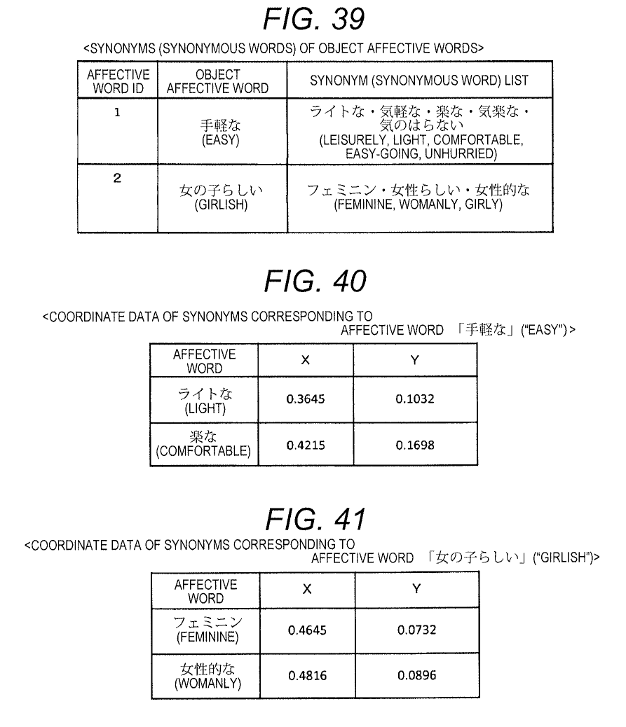

FIG. 39 illustrates an example of the synonym (synonymous term) of the object affective word ┌ [symbol] ┘ (“Easy”) and an example of the synonym (synonymous term) of the object affective word ┌ [symbol] ┘ (“Girlish”). The taste calculation unit 24 extracts plural synonyms from the synonym list. As an example, the affective words ┌ [symbol] ┘ (“Light”) and ┌ [symbol] ┘ (“Comfortable”) are extracted as the synonyms for the object affective word ┌ [symbol] ┘ (“Easy”), and the affective words ┌ [symbol] ┘ (“Feminine”) and ┌ [symbol] ┘ (“Womanly”) are extracted as the synonyms for the object affective word ┌ [symbol] [symbol] ┘ (“Girlish”). The synonyms are registered in the relationship DB 18, as the affective words. FIG. 40 illustrates the coordinates of the synonyms corresponding to the object affective word ┌ [symbol] ┘ (“Easy”), and FIG. 41 illustrates the coordinates of the synonyms corresponding to the object affective word ┌ [symbol] ┘ (“Girlish”).

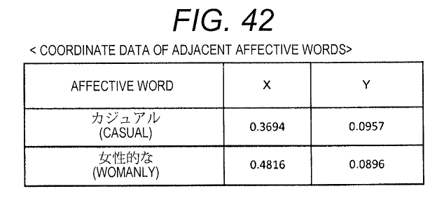

Next, the taste calculation unit 24 determines the temporary coordinates of the object affective word ┌ [symbol] ┘ (“Easy”), on the image map, by using two synonyms corresponding to the object affective word ┌ [symbol] ┘ (“Easy”). Specifically, the taste calculation unit 24 makes a circle including the coordinates of two synonyms on the image map, and estimates the center coordinates of the circle as the temporary coordinate A of the object affective word ┌ [symbol] ┘ (“Easy”). Similarly, the taste calculation unit 24 makes a circle including the coordinates of two synonyms corresponding to the object affective word ┌ [symbol] ┘ (“Girlish”), and estimates the center coordinates of the circle as the temporary coordinate B of the object affective word ┌ [symbol] ┘ (“Girlish”). Next, the taste calculation unit 24 makes a circle including the temporary coordinates A, B, specifies the center coordinate C of the circle, and specifies the affective word (adjacent affective word) adjacent to the center coordinate C, on the image map. For example, the affective word that is closest to the center coordinates C, and the affective word that is second closest thereto are selected as the adjacent affective words. As an example, it is assumed that affective words ┌ [symbol] ┘ (“Casual”) and ┌ [symbol] ┘ (“Natural”) are selected as the adjacent affective words. FIG. 42 illustrates the coordinates of the adjacent affective words. In addition, three or more adjacent affective words may be selected.

Next, similarly to Example 5, the taste calculation unit 24 acquires the affective score raw data of each adjacent affective word, calculates the contribution Rate of each adjacent affective word according to the above Equation (4), and calculates the affective score of each design element according to the above Equation (5). Thus, the affective score raw data for the combined taste in which tastes ┌ [symbol] ┘ (“Easy”) and ┌ [symbol] ┘ (“Girlish”) are combined is calculated (estimated). The taste calculation unit 24 determines a conforming design element that conforms to the combined taste ┌ [symbol] ┘ (“Easy, Girlish”), based on the affective score raw data for the combined taste. Thus, the affective evaluation data for the combined taste ┌ [symbol] [symbol] ┘ (“Easy, Girlish”) is calculated (estimated). The design creation unit 26 generates data (image data, template data, and the like) indicating the design of the object “Clothes (overcoat)”, by using each design element that is included in the affective evaluation data. The data is transmitted from the design creation device 10 to the terminal device 12, and the image, the template, and the like of Clothes (overcoat) are displayed on the UI unit 34 of the terminal device 12.

Through the above process, in a case where plural object affective words which are designated by the user are not stored in any of the affective evaluation DB 16 and the relationship DB 18, the object is designed by selecting the adjacent affective word based on the synonym (synonymous term) of each object affective word, and performing interpolation using each design element associated with the adjacent affective word. Thus, the design with the same taste as or a taste close to the combined taste (a taste obtained by combining the plural specified tastes) is created. The process according to Example 6 may be applied to the object other than Clothes.

In the above examples, the affective scores obtained by performing an affective evaluation experiment on those who are native speakers of Japanese are used. Therefore, the above examples are applied to Japanese. However, the present invention is not limited thereto. If affective scores obtained by performing an affective evaluation experiment on those who are native speakers of certain language (for example, English) are used, it is possible to apply the above exemplary embodiments to the certain language (for example, English).

The above-mentioned design creation device 10 is realized by cooperation of hardware resources and software as an example. Specifically, the design creation device 10 is provided with a processor such as a CPU which is not illustrated. The function of each part of the design creation device 10 can be realized by the processor reading and executing the program stored in a storage device which is not illustrated. The above program is stored in the storage device, through a recording medium such as a CD or DVD, or, through a communication path such as a network. Alternatively, each part of the design creation device 10 may be realized by, for example, hardware resources such as a processor or an electronic circuit. A device such as a memory may be used in the realization. As another example, each part of the design creation device 10 may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storing unit that stores affective information indicating an impression, and a design element which defines designs and conforms to the impression indicated by the affective information, in association with each other;
a receiving unit that receives object affective information indicating an impression for an object of design creation; and
a creation unit, wherein
in a case where the object affective information is stored in the storing unit, the creation unit creates an output related to design for the object by using a design element associated with the object affective information, and
in a case where the object affective information is not stored in the storing unit, the creation unit creates the output by performing interpolation using a design element associated with other affective information which is stored in the storing unit and for which a relationship with the object affective information is defined.

2. The information processing apparatus according to claim 1,
wherein the other affective information is affective information indicating an impression which is included in an adjacent range of the impression indicated by the object affective information.

3. The information processing apparatus according to claim 1,
wherein in the case where the object affective information is not stored in the storing unit, the creation unit determines a design element that conforms to the impression indicated by the object affective information by using a difference between the impression indicated by the object affective information and the impression indicated by the other affective information and a degree of conformance of a design element to the impression indicated by the other affective information, and creates the output by using the determined design element.

4. The information processing apparatus according to claim 2,
wherein in the case where the object affective information is not stored in the storing unit, the creation unit determines a design element that conforms to the impression indicated by the object affective information, by using a difference between the impression indicated by the object affective information and the impression indicated by the other affective information, and a degree of conformance of a design element to the impression indicated by the other affective information, and creates the output by using the determined design element.

5. The information processing apparatus according to claim 3,
wherein in the case where the object affective information is not stored in the storing unit, the creation unit calculates degrees of conformance of a plurality of design elements to the impression indicated by the object affective information, by using the difference and the degrees of conformance, and selects the design element that conforms to the impression indicated by the object affective information from among the plurality of design elements based on the degrees of conformance.

6. The information processing apparatus according to claim 4,
wherein in the case where the object affective information is not stored in the storing unit, the creation unit calculates degrees of conformance of a plurality of design elements to the impression indicated by the object affective information, by using the difference and the degrees of conformance, and selects the design element that conforms to the impression indicated by the object affective information from among the plurality of design elements based on the degrees of conformance.

7. The information processing apparatus according to claim 1,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

8. The information processing apparatus according to claim 2,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

9. The information processing apparatus according to claim 3,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

10. The information processing apparatus according to claim 4,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

11. The information processing apparatus according to claim 5,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

12. The information processing apparatus according to claim 6,
wherein the receiving unit further receives affective information to be excluded that indicates an impression to be excluded, and
wherein in the case where the object affective information is not stored in the storing unit, the creation unit selects affective information that has a smaller difference from the impression indicated by the object affective information than a difference from the impression indicated by the affective information to be excluded, from an affective information group that is stored in the storing unit, as the other affective information.

13. The information processing apparatus according to claim 1,
wherein the object affective information is an object affective word indicating the impression, and
wherein in the case where the object affective information is not stored in the storing unit, and the other affective information, for which the relationship with the object affective information is defined, is not stored in the storing unit, the creation unit estimates a temporary impression for the object affective word based on an impression indicated by a synonym of the object affective word, and selects affective information indicating an impression included in an adjacent range of the temporary impression as the other affective information.

14. The information processing apparatus according to claim 2,
wherein the object affective information is an object affective word indicating the impression, and
wherein in the case where the object affective information is not stored in the storing unit, and the other affective information, for which the relationship with the object affective information is defined, is not stored in the storing unit, the creation unit estimates a temporary impression for the object affective word based on an impression indicated by a synonym of the object affective word, and selects affective information indicating an impression included in an adjacent range of the temporary impression as the other affective information.

15. The information processing apparatus according to claim 3,
wherein the object affective information is an object affective word indicating the impression, and
wherein in the case where the object affective information is not stored in the storing unit, and the other affective information, for which the relationship with the object affective information is defined, is not stored in the storing unit, the creation unit estimates a temporary impression for the object affective word based on an impression indicated by a synonym of the object affective word, and selects affective information indicating an impression included in an adjacent range of the temporary impression as the other affective information.

16. The information processing apparatus according to claim 4,
wherein the object affective information is an object affective word indicating the impression, and
wherein in the case where the object affective information is not stored in the storing unit, and the other affective information, for which the relationship with the object affective information is defined, is not stored in the storing unit, the creation unit estimates a temporary impression for the object affective word based on an impression indicated by a synonym of the object affective word, and selects affective information indicating an impression included in an adjacent range of the temporary impression as the other affective information.

17. The information processing apparatus according to claim 5,
wherein the object affective information is an object affective word indicating the impression, and
wherein in the case where the object affective information is not stored in the storing unit, and the other affective information, for which the relationship with the object affective information is defined, is not stored in the storing unit, the creation unit estimates a temporary impression for the object affective word based on an impression indicated by a synonym of the object affective word, and selects affective information indicating an impression included in an adjacent range of the temporary impression as the other affective information.

18. The information processing apparatus according to claim 13,
wherein in a case where a plurality of different object affective words are received by the receiving unit, the creation unit estimates the temporary impression based on synonyms of the respective object affective words.

19. An information processing method comprising:
receiving object affective information indicating an impression for an object of design creation;
in a case where the object affective information is stored in a storing unit that stores affective information indicating an impression, and a design element which defines designs and conforms to the impression indicated by the affective information in association with each other, creating an output related to design for the object by using a design element associated with the object affective information; and
in a case where the object affective information is not stored in the storing unit, creating the output by performing interpolation using a design element associated with other affective information which is stored in the storing unit and for which a relationship with the object affective information is defined.

20. A non-transitory computer readable medium storing a program causing a computer to execute information processing, the computer provided with a storing unit that stores affective information indicating an impression, and a design element which defines designs and conforms to the impression indicated by the affective information, in association with each other, the information processing comprising:
receiving object affective information indicating an impression for an object of design creation;
in a case where the object affective information is stored in the storing unit, creating an output related to design for the object by using a design element associated with the object affective information; and
in a case where the object affective information is not stored in the storing unit, creating the output by performing interpolation using a design element associated with other affective information which is stored in the storing unit and for which a relationship with the object affective information is defined.
